(19) United States
(12) Patent Application Publication
(10) Pub. No.: US 2025/0203194 A1
(43) Pub. Date: Jun. 19, 2025

(54) IMAGE PROCESSING DEVICE, IMAGE PROCESSING METHOD, AND PROGRAM

(71) Applicant: SONY GROUP CORPORATION, TOKYO (JP)

(72) Inventor: HIROSHI IKEDA, TOKYO (JP)

(21) Appl. No.: 18/848,310

(22) PCT Filed: Feb. 24, 2023
(86) PCT No.: PCT/JP2023/006807

§ 371 Date: Sep. 18, 2024

(30) Foreign Application Priority Data
Mar. 28, 2022 (JP) 2022-051164

(51) Int. Cl. H04N 23/63; G06T 7/11; G06T 7/70; G06V 20/70; H04N 23/611; H04N 23/67; H04N 23/69; H04N 23/88

(52) U.S. Cl. CPC H04N 23/632; G06T 7/11; G06T 7/70; H04N 23/611; H04N 23/675; H04N 23/69; H04N 23/88; G06T 2207/20081; G06T 2207/20132; G06T 2207/30201; G06V 20/70

(57) ABSTRACT

It is possible to generate an image captured with a camera control parameter optimum for a clipped image of a partial region of a captured image by a camera, and to distribute, display, or record the image. The image processing device includes: a clipping execution unit that generates a clipped image obtained by clipping a partial region from a captured image by a camera; a camera control parameter determination unit that determines a camera control parameter optimum for the cut-out image; and a camera control unit that causes the camera to execute image capturing to which the camera control parameter determined by the camera control parameter determination unit is applied. The camera control parameter determination unit determines a camera control parameter of at least one of focus, exposure, white balance (WB), shutter speed, or aperture optimum for the clipped image.

### TECHNICAL FIELD

The present disclosure relates to an image processing device, an image processing method, and a program. More specifically, the present disclosure relates to an image processing device, an image processing method, and a program capable of improving the image quality of a clipped image to be subjected to recording processing, display processing, or distribution processing in a configuration in which a partial image region is clipped from a camera-captured image and recorded, displayed, or distributed.

### BACKGROUND ART

In broadcasting, video distribution, or video recording processing, there is a case where a clipped image obtained by clipping only a partial region from an image captured by a camera is generated and processing of distributing or recording the clipped image is performed.

For example, in the case of generating a relay image or a recorded image of various performances performed on a stage such as a music live show, processing of distributing or recording a clipped image generated by clipping only an image region of one specific performer from a captured image of a plurality of performers (performers) is performed.

In addition, for example, in a soccer game or the like, there is also a case where only an image region of a specific player is clipped from a camera-captured image in a wide range around a ball, and processing of distributing or processing of recording the image region is performed.

In recent years, by using AI analysis using a machine learning model such as a deep neural network (DNN: Deap Neural Network), which is a multilayer neural network, it is possible to perform processing of detecting and tracking a specific person from an image with high accuracy, and processing of clipping a specific subject at an appropriate angle of view from a camera-captured image using such AI analysis and distributing or recording the specific subject has been actively performed.

However, in the image capturing stage by a camera, camera control is executed according to the brightness of the entire captured image, the subject distance, the color, and the like. Specifically, for example, various camera control parameters such as focus, exposure, and white balance (WB) are optimally adjusted according to the entire captured image, and the capturing processing is executed.

This camera control parameter is a parameter optimum for the entire camera-captured image, and this parameter may not be the optimum parameter for a clipped image that is clipped from the captured image.

For example, it is assumed that a television camera captures a bird's-eye view video of a wide region in which a sunlit region and a shaded region are mixed in a soccer relay image in the daytime, or the like. In a case where the brightness of the region exposed to the sunlight is large in this captured image, the image is captured with parameter setting in which the exposure is entirely suppressed. As a result, the luminance of the shaded portion in the captured image extremely decreases.

When a clipped image of a player in a shaded portion is generated from such an image, the image is very dark and the face of the player cannot be discriminated in some cases. Such an image is inappropriate as an image to be distributed, displayed, or recorded.

Note that, for example, Patent Document 1 (Japanese Patent Application Laid-Open No. 2006-222816) discloses a conventional technique that discloses a configuration in which a partial region is clipped from a camera-captured image and the image quality of the clipped image is adjusted.

However, the configuration described in Patent Document 1 performs image quality adjustment by performing image processing on a clipped image after performing image clipping processing on the captured image by a camera, and does not adjust and control camera control parameters at the time of image capturing by the camera in accordance with the clipping region.

In the configuration described in Patent Document 1, it is possible to perform correction to adjust an image region that has been darkly captured to a bright image, but there is a limit to the correction because the amount of information included in each pixel of the dark image is small.

### CITATION LIST

### Patent Document

Patent Document 1: Japanese Patent Application Laid-Open No. 2006-222816

### SUMMARY OF THE INVENTION

### Problems to be Solved by the Invention

The present disclosure has been made in view of the above problems, for example, and an object of the present disclosure is to provide an image processing device, an image processing method, and a program capable of improving the image quality of a clipped image to be subjected to recording processing, display processing, and distribution processing in a configuration in which a partial image region is clipped from a camera-captured image and recorded, displayed, or distributed.

An object of the present disclosure is to provide an image processing device, an image processing method, and a program capable of executing improvement in the image quality of a clipped image quickly and with high accuracy by calculating a camera control parameter optimum for the clipped image in parallel with image capturing processing by a camera, and performing image capturing using the calculated camera control parameter in a configuration in which a partial image region is clipped from a camera-captured image and recorded, displayed, or distributed.

### Solutions to Problems

A first aspect of the present disclosure is an image processing device including:
a clipping execution unit that generates a clipped image obtained by clipping a partial region from a captured image by a camera;
a camera control parameter determination unit that determines a camera control parameter optimum for the clipped image; and
a camera control unit that causes the camera to execute image capturing to which the camera control parameter determined by the camera control parameter determination unit is applied.

Further, a second aspect of the present disclosure is an image processing method executed in an image processing device, the method executing:
an image clipping step of generating, by a clipping execution unit, a clipped image obtained by clipping a partial region from a captured image by a camera;
a camera control parameter determination step of determining, by a camera control parameter determination unit, a camera control parameter optimum for the clipped image; and
a camera control step of causing, by a camera control unit, the camera to execute image capturing to which the camera control parameter determined in the camera control parameter determination step is applied.

Further, a third aspect of the present disclosure is a program for causing an image processing device to execute image processing, the program causing the image processing device to execute:
an image clipping step of causing a clipping execution unit to generate a clipped image obtained by clipping a partial region from a captured image by a camera;
a camera control parameter determination step of causing a camera control parameter determination unit to determine a camera control parameter optimum for the clipped image; and
a camera control step of causing a camera control unit to execute causing the camera to execute image capturing to which the camera control parameter determined in the camera control parameter determination step is applied.

Note that the program of the present disclosure is a program that can be provided by, for example, a storage medium or a communication medium provided in a computer-readable format to an image processing device or a computer system that can execute various program codes. By providing such a program in a computer-readable format, processing corresponding to the program is implemented on the image processing device or the computer system.

Other objects, features, and advantages of the present disclosure will become apparent from a more detailed description based on embodiments of the present disclosure described below and the accompanying drawings. Note that a system described herein is a logical set configuration of a plurality of devices, and is not limited to a system in which devices with respective configurations are in the same housing.

According to the configuration of an embodiment of the present disclosure, it is possible to generate an image captured with a camera control parameter optimum for a clipped image of a partial region of a captured image by a camera, and to distribute, display, or record the image.

Specifically, for example, the image processing device includes: a clipping execution unit that generates a clipped image obtained by clipping a partial region from a captured image by a camera; a camera control parameter determination unit that determines a camera control parameter optimum for the cut-out image; and a camera control unit that causes the camera to execute image capturing to which the camera control parameter determined by the camera control parameter determination unit is applied. The camera control parameter determination unit determines a camera control parameter of at least one of focus, exposure, white balance (WB), shutter speed, or aperture optimum for the clipped image.

With this configuration, it is possible to generate an image captured with a camera control parameter optimum for a clipped image of a partial region of a captured image by a camera, and to distribute, display, or record the image.

Note that the effects described herein are merely examples and are not limited, and additional effects may also be provided.

### BRIEF DESCRIPTION OF DRAWINGS

FIG. 1 is a diagram illustrating an outline of image clipping processing.

FIG. 2 is a diagram illustrating an outline of the image clipping processing.

FIG. 3 is a diagram illustrating an outline of the image clipping processing and distributing, displaying, and recording processing of a clipped image.

FIG. 4 is a diagram illustrating a problem in the image clipping processing.

FIG. 5 is a diagram illustrating a problem in the image clipping processing.

FIG. 6 is a diagram illustrating a problem in the image clipping processing.

FIG. 7 is a diagram illustrating a sequence of processing executed by an image processing device of the present disclosure.

FIG. 8 is a diagram illustrating a specific example of image analysis processing executed by the image processing device of the present disclosure.

FIG. 9 is a diagram illustrating a specific example of the image clipping processing executed by the image processing device of the present disclosure.

FIG. 10 is a diagram illustrating a specific example of the image clipping processing executed by the image processing device of the present disclosure.

FIG. 11 is a diagram illustrating a specific example of camera control processing executed by the image processing device according to the present disclosure.

FIG. 12 is a diagram illustrating a specific example of the camera control processing executed by the image processing device of the present disclosure.

FIG. 13 is a diagram illustrating a specific example of the camera control processing executed by the image processing device according to the present disclosure.

FIG. 14 is a diagram illustrating a specific example of the camera control processing executed by the image processing device according to the present disclosure.

FIG. 15 is a diagram illustrating an example in which the processing of the present disclosure is applied to a PTZ camera.

FIG. 16 is a diagram illustrating a processing sequence in a case where the processing of the present disclosure is applied to a PTZ camera.

FIG. 17 is a diagram illustrating a configuration and processing of a camera as an example of the image processing device of the present disclosure.

FIG. 18 is a diagram illustrating a configuration and processing in a case where image processing of the present disclosure is executed by a camera and an external device.

FIG. 19 is a diagram illustrating a configuration and processing in a case where the image processing of the present disclosure is executed by a camera and an external device.

FIG. 20 is a diagram illustrating a configuration example of a camera, which is an example of the image processing device of the present disclosure.

FIG. 21 is a diagram illustrating a configuration example of a camera and an external device, which is an example of the image processing device of the present disclosure.

FIG. 22 is a diagram illustrating a configuration example of a camera and an external device, which is an example of the image processing device of the present disclosure.

FIG. 23 is a flowchart illustrating a sequence of processing executed by the image processing device of the present disclosure.

FIG. 24 is a flowchart illustrating a sequence of processing executed by the image processing device of the present disclosure.

FIG. 25 is a diagram illustrating a configuration example of a GUI of the image processing device of the present disclosure.

FIG. 26 is a diagram illustrating a configuration example of the GUI of the image processing device of the present disclosure.

FIG. 27 is a diagram illustrating a configuration example of the GUI of the image processing device of the present disclosure.

FIG. 28 is a diagram illustrating a configuration example of the GUI of the image processing device of the present disclosure.

FIG. 29 is a diagram illustrating a hardware configuration example of the image processing device of the present disclosure.

### MODE FOR CARRYING OUT THE INVENTION

Hereinafter, details of an image processing device, and an image processing method, and a program of the present disclosure will be described with reference to the drawings. Note that the description will be given in the following order.
1. Outline of Image Clipping Processing
2. Processing Executed by Image Processing Device of Present Disclosure
3. Processing Example using PTZ Camera
4. Configuration Example of Image Processing Device of Present Disclosure
5. Detailed Configuration of Image Processing Device of Present Disclosure
6. Sequence of Processing Executed by Image Processing Device of Present Disclosure
7. Example of GUI Applicable to Designation Processing of Clipping Image Region and the like
8. Hardware Configuration Example of Image Processing Device
9. Summary of Configuration of Present Disclosure

### 1. Outline of Image Clipping Processing

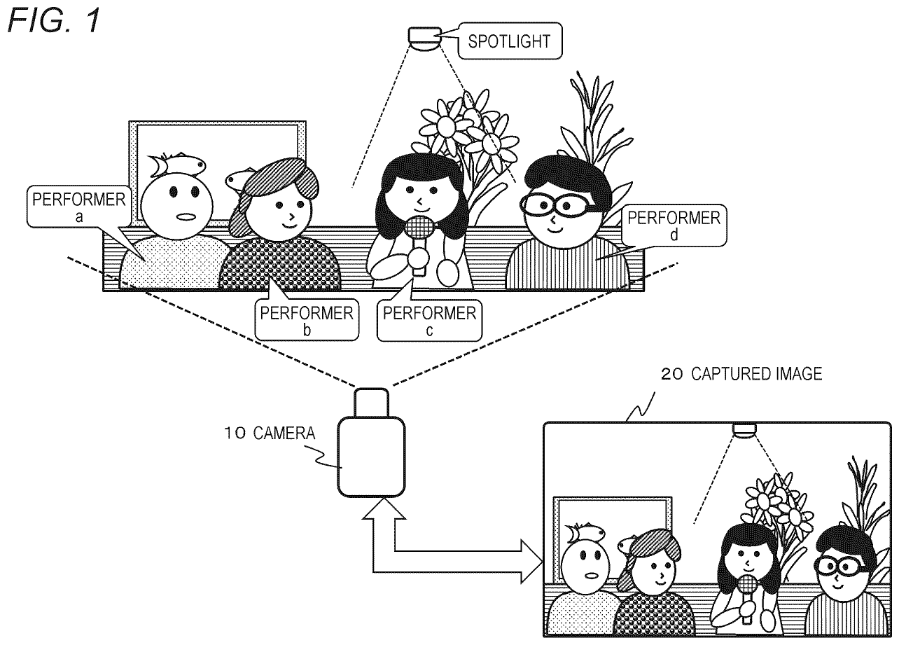

First, an outline of image clipping processing will be described with reference to FIG. 1 and the subsequent drawings.

FIG. 1 illustrates, for example, a state in which a live talk show on a stage or in a television studio is captured by a camera 10 such as a television camera, and an example of a captured image 20 by the camera 10.

The camera 10 performs image capturing by setting an angle of view at which the entire four performers a to d, who are live talk performers, can be captured.

An example of a captured image by the camera 10 is the camera-captured image 20 illustrated in the lower right of FIG. 1.

Note that the image captured by the camera 10 is a moving image (video), and the captured image 20 illustrated in the lower right of FIG. 1 is one image frame constituting the moving image (video) captured by the camera 10.

When capturing an image, the camera 10 sets a camera control parameter optimum for the entire image to be captured and executes image capturing processing.

Specifically, image capturing is executed while automatically adjusting camera control parameters such as focus, exposure, white balance (WB), shutter speed, and aperture (blur amount).

The camera control parameters to be automatically adjusted are determined according to the brightness, motion, color, and the like of a subject included in the entire image region captured by the camera 10.

In the live talk show captured by the camera 10 illustrated in FIG. 1, the four performers a to d appear, but a performer c is irradiated with a spotlight, and only a region of the performer c is in a brighter state than other regions.

The regions of the performers a, b, and d are set to be darker than the region of the performer c.

The camera 10 sets camera control parameters such as exposure according to average brightness of the entire region including the performers a to d, and captures the captured image 20. That is, the captured image 20 is captured while automatically adjusting the parameters to optimum parameters for the entire captured image 20.

In a case where the captured image 20 illustrated in the lower right of FIG. 1 is distributed, displayed, or recorded as it is, distribution processing, display processing, or recording processing of the image captured under the optimum parameters for the entire captured image is performed.

However, in recent years, there is a case where processing of clipping only a partial image region from an image captured by a camera and distributing processing, display processing, or recording processing of the clipped image are performed.

As described above, for example, by using the AI analysis using at least one of the machine learning model such as the deep neural network (DNN: Deap Neural Network), which is a multilayer neural network, or the rule-based model, it is possible to perform processing of detecting and tracking a specific person from an image with high accuracy. In recent years, processing of tracking a specific subject from a camera-captured image using such AI analysis and clipping an image region thereof at an appropriate angle of view, and distributing, displaying, or recording the image region has been performed.

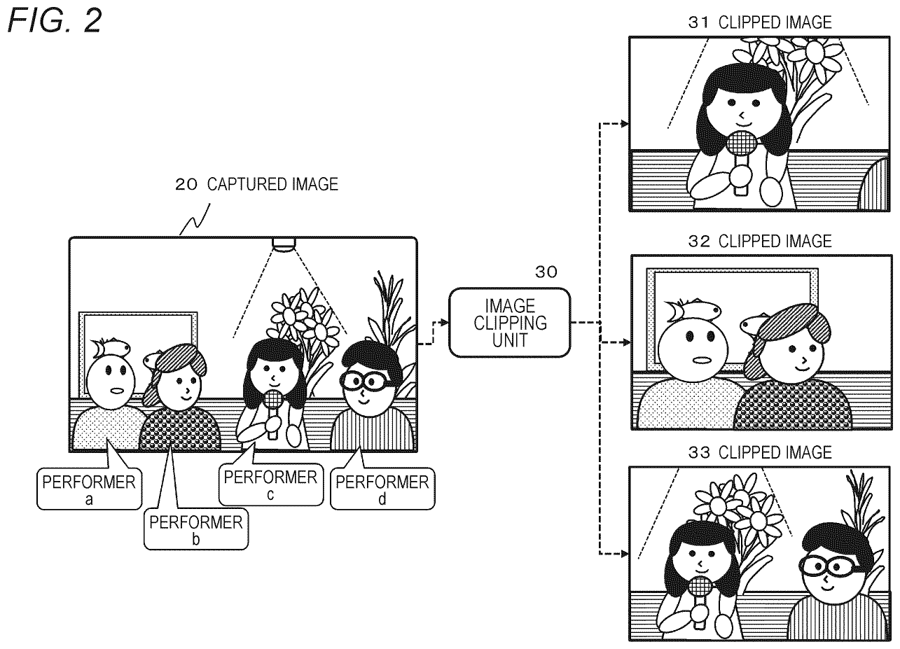

A specific example of the image clipping processing from the captured image 20 will be described with reference to FIG. 2.

The left side of FIG. 2 illustrates the captured image 20 captured by the camera 10 illustrated in FIG. 1.

The captured image 20 is input to an image clipping unit 30, and the image clipping unit 30 executes clipping processing of a partial image region from the captured image 20. With this image clipping processing, for example, various clipped images such as clipped images 31 to 33 illustrated in FIG. 2 are generated.

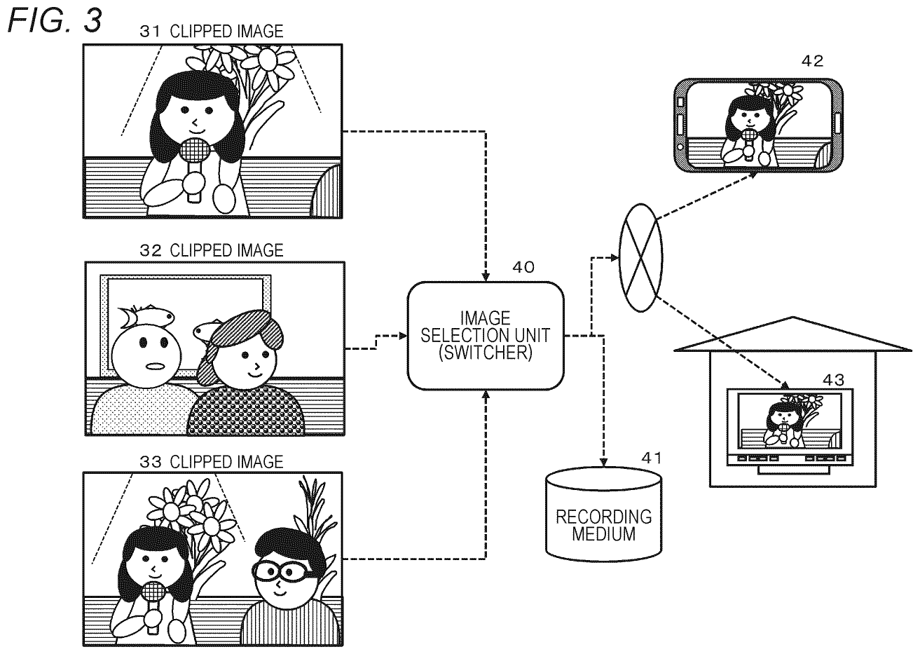

FIG. 3 is a diagram illustrating distribution processing, display processing, and recording processing of the clipped images 31 to 33.

The clipped images 31 to 33 are input to an image selection unit (switcher) 40.

The image selection unit (switcher) 40 selects a clipped image to be distributed, a clipped image to be displayed, or a clipped image to be recorded. The clipped image selected by the image selection unit (switcher) 40 is distributed to each of user terminals 42 and 43 via broadcast or a communication network such as the Internet. Alternatively, the clipped image is displayed on a display unit of an external device connected to the camera 10 in a wireless or wired manner. Alternatively, the clipped image is recorded in the recording medium 41.

However, as a problem of such distribution processing, display processing, and recording processing of the clipped image, there is a problem in that the clipped image is not an image captured under the settings of the camera control parameters (focus, exposure, white balance (WB), shutter speed, aperture (blur amount), and the like) optimum for the clipped image.

That is, as described above with reference to FIG. 1, the original image from which the clipped image has been clipped is the captured image 20 illustrated in FIG. 1, and the camera control parameters (focus, exposure, white balance (WB), shutter speed, aperture (blur amount), and the like) are values calculated as parameters optimum for the entire image region of the captured image 20.

Therefore, the captured image 20 is captured under parameters different from the parameters optimum for each of the clipped images 31 to 33 illustrated in FIGS. 2 and 3.

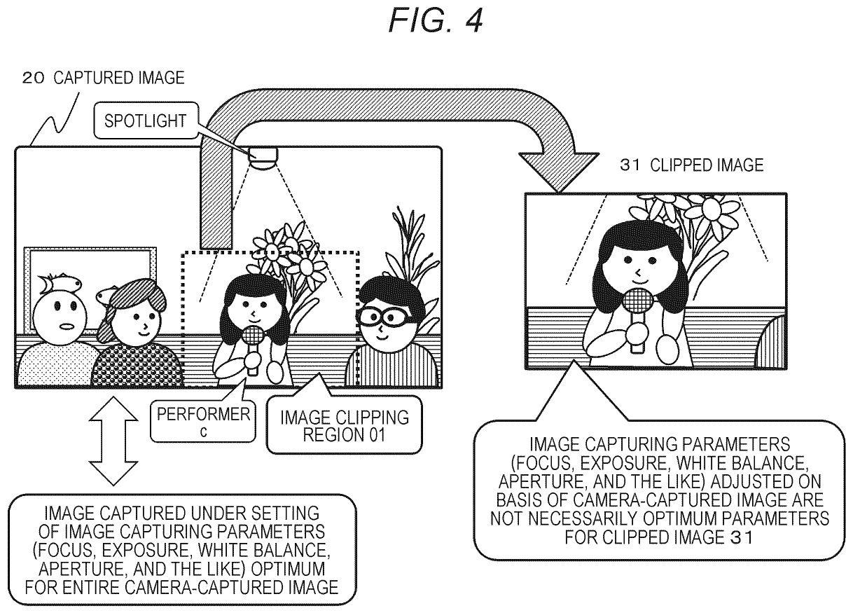

For example, as illustrated in FIG. 4, the clipped image 31 is an image obtained by clipping an image region (an image clipping region 01) of the performer c of the captured image 20. Since the performer c is irradiated with a spotlight, the image region is brighter than other image regions. However, the captured image 20 is an image including many other portions not irradiated with the spotlight, and the exposure of the captured image 20 at the time of capturing is automatically adjusted in consideration of the portions not irradiated with the spotlight. As described above, in the case of capturing the captured image 20, the exposure is set to be larger than that in the case of capturing the image of only the image clipping region 01 (corresponding to the clipped image 31).

Therefore, when the image clipping region 01 in the captured image 20 captured with the larger exposure setting is observed alone, the image is slightly too bright.

The same applies to the camera control parameters other than exposure, that is, parameters such as focus, white balance (WB), shutter speed, and aperture (blur amount). These camera control parameters are automatically adjusted as parameters optimum for the entire captured image 20, and may be parameters inappropriate for the clipped image 31.

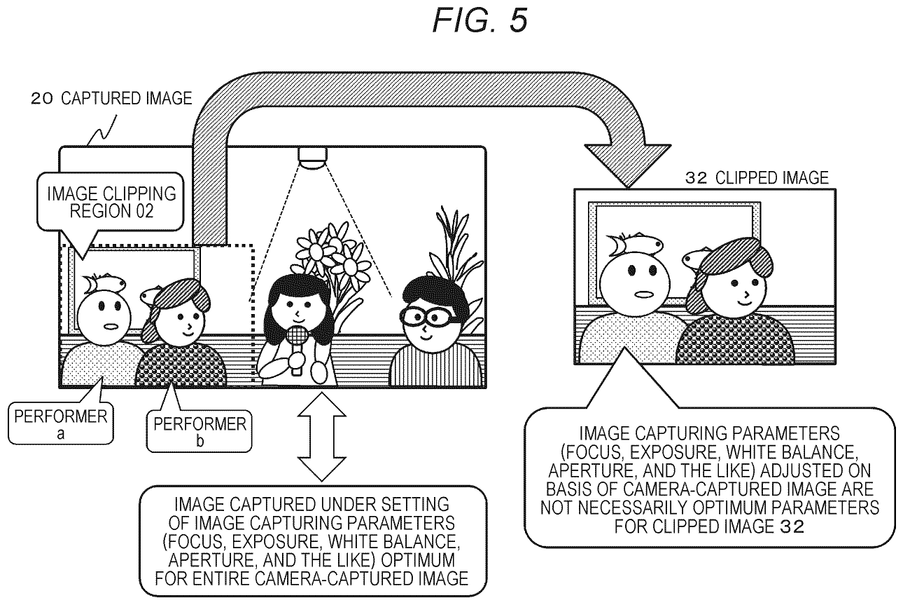

FIG. 5 illustrates a clipping example of the clipped image 32. The clipped image 32 is an image obtained by clipping an image region (an image clipping region 02) of the performers a and b of the captured image 20. The performers a and b are not irradiated with a spotlight, and for example, the image region is darker than the image region of the performer c. However, the captured image 20 is an image including a portion not irradiated with the spotlight, and the exposure of the captured image 20 at the time of capturing is automatically adjusted in consideration of the portion not irradiated with the spotlight. As described above, in the case of capturing the captured image 20, the exposure is set to be smaller than that in the case of capturing the image of only the image clipping region 02 (corresponding to the clipped image 32).

Therefore, when the image clipping region 02 in the captured image 20 captured with the smaller exposure setting is observed alone, the image is slightly too dark.

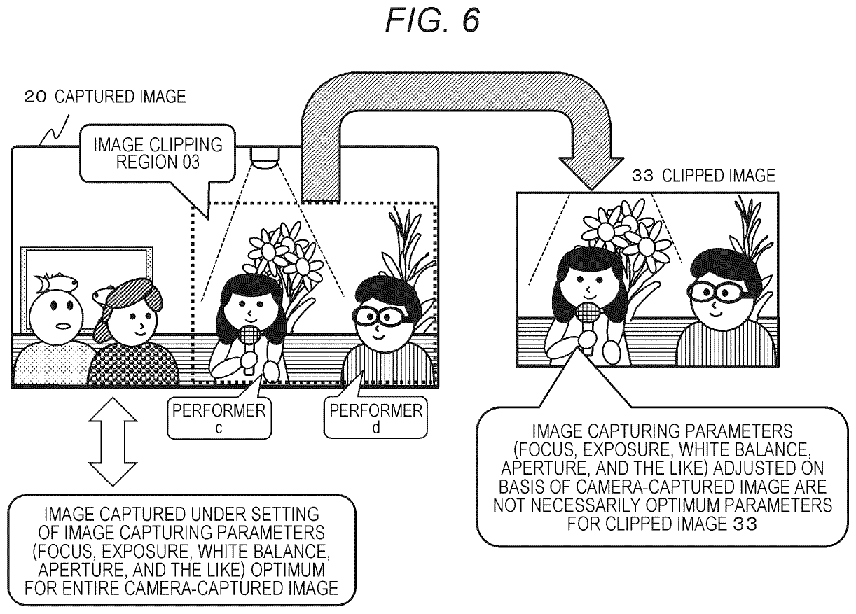

FIG. 6 illustrates a clipping example of the clipped image 33. The clipped image 33 is an image obtained by clipping an image region (an image clipping region 03) of the performers c and d of the captured image 20. A part of the performers c and d is irradiated with a spotlight.

Even in such a clipped image 33, the exposure of the captured image 20 at the time of capturing is not necessarily optimum.

As described above, the clipped images 31 to 33 generated by clipping a part of the captured image 20, which is a bird's-eye view image including one large capturing region, are different from the image captured by applying the camera control parameters optimum for the clipped image, and thus, there is a problem in that the image quality is degraded.

The present disclosure solves such a problem. Hereinafter, a configuration and processing of the image processing device of the present disclosure will be described.

### 2. Processing Executed by Image Processing Device of Present Disclosure

Next, the processing executed by the image processing device of the present disclosure will be described.

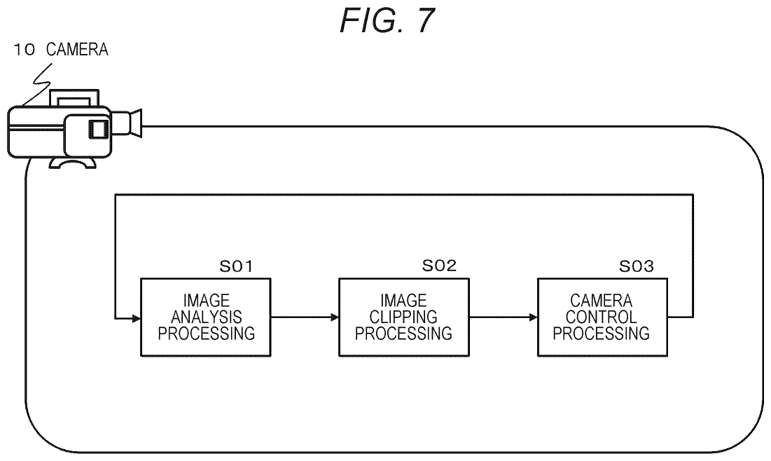

FIG. 7 is a diagram illustrating processing executed by the image processing device of the present disclosure.

An example of the image processing device of the present disclosure is, for example, a camera such as the camera 10 described above with reference to FIG. 1.

Note that the image processing device of the present disclosure is not limited to a camera, and can be configured as various devices such as a PC, a server, and a broadcasting device that execute processing by receiving a captured image by the camera as an input. Specific examples thereof will be described later.

Hereinafter, first, an embodiment in which all the image processing of the present disclosure is executed in a camera will be described as an example of the image processing device of the present disclosure.

FIG. 7 illustrates three pieces of processing executed by the camera 10. The camera 10 sequentially and repeatedly executes the following three pieces of processing.
Step S01=image analysis processing
Step S02=image clipping processing
Step S03=camera control processing

The camera 10 is a camera that captures a moving image (video), and repeatedly executes the processing of steps S01 to S03 for each frame captured by the camera 10 or for each of a plurality of frames.

The image analysis processing in step S01 is analysis processing of the captured image captured by the camera 10. For example, detection of a person to be clipped, detection processing of a face region, and the like are performed.

The image clipping processing in step S02 is processing of clipping a partial image region of the captured image captured by the camera 10.

The camera control processing in step S03 is a step of calculating the camera control parameters optimum for the clipped image in step S02, that is, the camera control parameters optimum for image capturing of the region of the clipped image, and causing the camera 10 to execute image capturing by setting the calculated camera control parameters to the camera 10.

When the processing of step S03 is completed, the processing of steps S01 to S03 is repeatedly executed for the next processed image frame to be captured by the camera 10.

Note that, in the image clipping processing in step S02, the operator can determine the image clipping region and clip the image, and it is also possible to perform processing of clipping an image with a predetermined angle of view according to a prescribed algorithm while detecting and tracking a specific person by using the AI analysis using at least one of the machine learning model such as the deep neural network or the rule-based model described above.

When the image clipping position is different, the optimum camera control parameters also differ according to the clipped image.

In step S03, the camera control parameters optimum for the latest clipped image that is newly clipped in step S02 is calculated.

This latest calculated camera control parameter is sequentially set in the camera 10, and the next image capturing is executed.

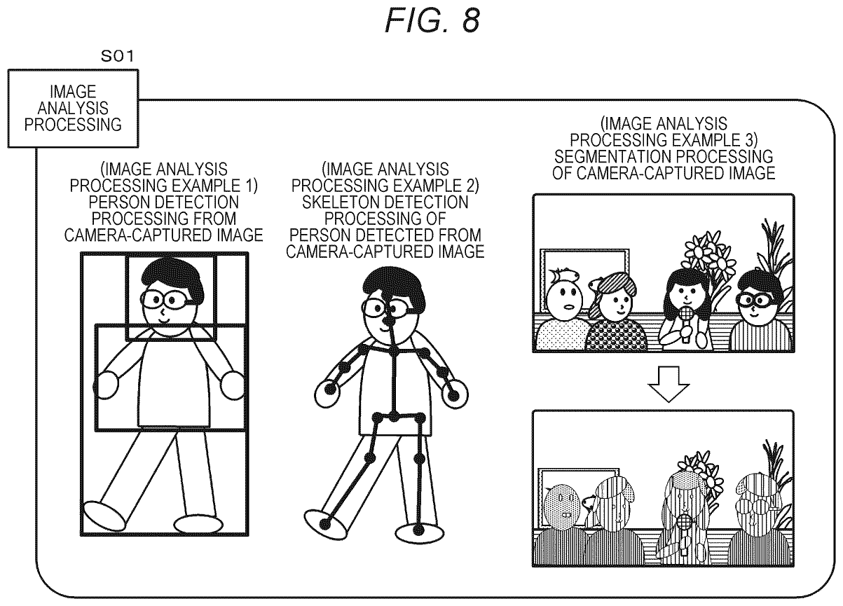

The three pieces of processing illustrated in FIG. 7 executed by the image processing device (the camera 10 in the present embodiment) of the present disclosure, that is,
Step S01=image analysis processing
Step S02=image clipping processing
Step S03=camera control processing,
details of these three pieces of processing will be described with reference to FIG. 8 and subsequent drawings.

### (2-1. Image Analysis Processing in Step S01)

First, details of the image analysis processing executed by the image processing device of the present disclosure will be described.

The image analysis processing in step S01 is analysis processing of the captured image captured by the camera 10. For example, detection processing of a person to be clipped, detection processing of a face region, and the like are performed.

FIG. 8 is a diagram illustrating a specific example of the image analysis processing executed by the image processing device of the present disclosure.

The image analysis processing is processing of analyzing a captured image captured by the camera 10, and for example, the captured image 20 illustrated in FIG. 1 is analyzed.

As the analysis processing, for example, processing of detecting an image region of a person who is a candidate for clipping from the captured image is executed.

FIG. 8 illustrates a specific example of detection processing of a person region from an image.

(An image analysis processing example 1) illustrated in FIG. 8 is person detection processing from a captured image captured by the camera 10. This person detection processing can be executed by applying existing processing such as pattern matching or face detection processing.

Note that a mode of the person detection processing includes detection processing of a head or a face region, detection processing of an upper body, detection processing of an entire body, and the like. The mode of performing the person detection processing is determined according to, for example, an algorithm of camera control in the camera 10, but may be determined according to a subject tracking algorithm determined in advance.

(An image analysis processing example 2) illustrated in FIG. 8 is skeleton detection processing of a person detected from a captured image captured by the camera 10. For example, a position of each part such as a head, a torso, an arm, a hand, and a foot of a person is detected.

(An image analysis processing example 3) illustrated in FIG. 8 is segmentation processing of the captured image captured by the camera 10, and is extraction processing of a person included in the image. Specifically, the processing can be executed as processing using semantic segmentation, for example.

The semantic segmentation is a type of image recognition processing, and is processing of identifying an object type in an image. The semantic segmentation is processing of estimating an object number (identification information, ID) corresponding to each pixel constituting the object according to the identified type of the object.

As described above, the semantic segmentation is a technology that makes it possible to identify which object category each of constituent pixels (pixels) of an image belongs to.

Note that FIG. 8 illustrates a processing example in a case where a person is detected from the captured image and is tracked as an example of the image analysis processing. However, in the image analysis processing executed by the image processing device of the present disclosure, processing of extracting and tracking various objects other than a person, for example, an animal, an automobile, a musical instrument, a ball, and the like from the captured image as analysis targets may be performed.

### (2-2. Image Clipping Processing in Step S02)

Next, the image clipping processing executed by the image processing device of the present disclosure will be described.

The image clipping processing in step S02 is processing of clipping a partial image region of the captured image captured by the camera 10.

For example, processing of clipping an image region including a face region, an upper body region, an entire body region, or the like of a person set as a tracking target is executed.

The clipping target is, for example, a person, but the clipping target is not limited to one person, and various settings such as a region including a plurality of persons can be made. Moreover, various settings such as an image region including not only a person but also an animal, an automobile, and other objects are possible. These clipping target subjects are persons and objects analyzed and detected in the image analysis processing in step S01.

Note that, as described above, the image clipping processing in step S02 can be executed as processing in which the operator determines and clips an image clipping region, or processing in which an image with a predetermined angle of view is clipped according to a prescribed algorithm while detecting and tracking a specific person by using the AI analysis using at least one of the machine learning model such as the deep neural network or the rule-based model.

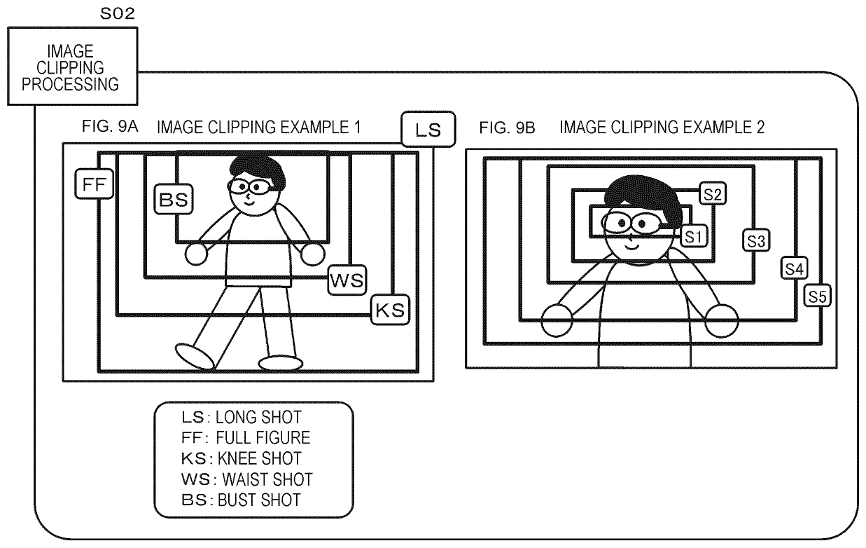

FIG. 9 illustrates a setting example of the clipping region in a case where the clipping target is a person as an example of the image clipping processing executed by the image processing device of the present disclosure.

(a) An image clipping example 1 is a clipping example in a case where the entire person image is detected from a captured image.

BS (bust shot) is an example in which a region including the upper portion of the chest of the person is set as a clipping region.

WS (waist shot) is an example in which a region including above the waist of the person is set as a clipping region.

NS (knee shot) is an example in which a region including above the knee of the person is set as a clipping region.

FF (full figure) is an example in which a region including the entire person is set as a clipping region.

LS (long shot) is an example in which an image region including the entire person and observed from a further distance is set as a clipping region.

The setting of the image clipping region for a person is not limited thereto, and for example, as in an image clipping example 2 illustrated in FIG. 9(b), it is also possible to set a further segmented clipping mode.

FIG. 9(b) illustrates five types of clipping examples from a clipping example (s1) of only the eye portion of the person to a clipping region (s5) of the upper body.

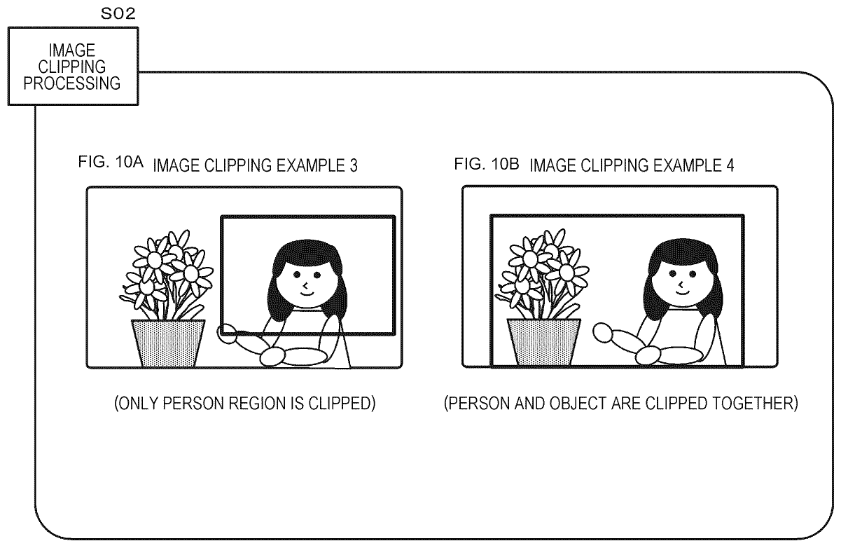

The image clipping processing executed by the image processing device of the present disclosure is not limited to only the person region. FIG. 10 illustrates an example (c) in which only a person region is set as a clipping region from the captured image, and an example (d) in which a region including a person and an object (flower) is set as a clipping region.

The image clipping processing executed in step S02 by the image processing device of the present disclosure is executed as processing of clipping an image region from a captured image, the image region including at least one of various objects (a person, an animal, a ball, or other various objects) detected in the image analysis processing executed in step S01.

### (2-3. Camera Control Processing in Step S03)

Next, the camera control processing executed by the image processing device of the present disclosure will be described.

In step S03, camera control parameters optimum for the latest clipped image that is clipped in step S02 is calculated.

When at least one of the position or the size of the image clipping region is different, the subject and the background appearing in the clipped image are changed, and thus, the optimum camera control parameters are also different. The latest calculated camera control parameters are sequentially set in the camera 10, and the next image capturing is executed.

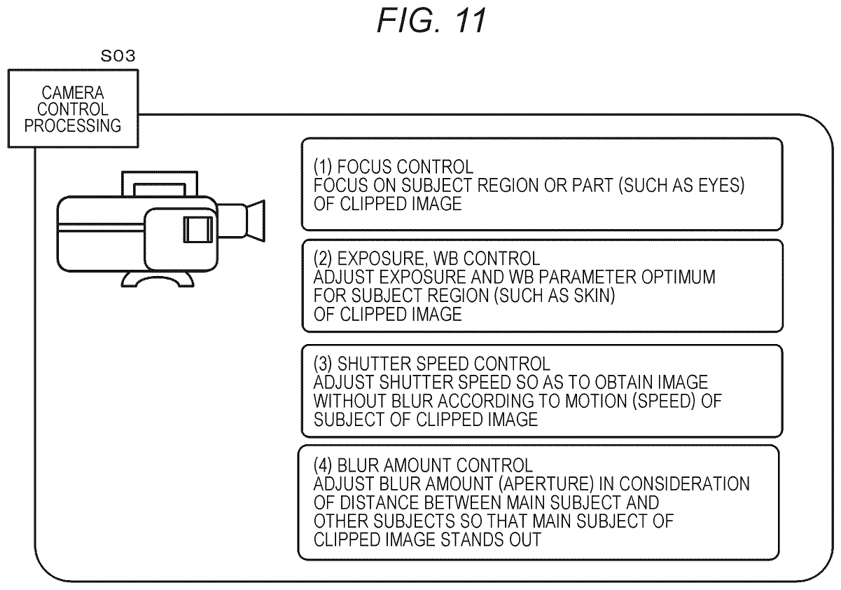

FIG. 11 is a diagram illustrating a specific example of the camera control processing executed by the image processing device of the present disclosure.

The camera control processing executed by the image processing device of the present disclosure is, for example, the following processing.
(1) Focus control
(2) Exposure, white balance (WB) control
(3) Shutter speed control
(4) Blur amount control

“(1) Focus control” is processing of focusing on a subject region or a part (such as eyes) of the clipped image. A focus parameter for focusing on a subject region or a part (such as eyes) of the clipped image is calculated, and the calculated parameter is set to the camera 10.

“(2) Exposure and white balance (WB) control” is processing of controlling exposure and white balance (WB) optimum for a subject region (such as skin) of the clipped image. Exposure and white balance (WB) parameters optimum for a subject region (such as skin) of the clipped image is calculated, and the calculated parameter is set in the camera 10.

“(3) Shutter speed control” is processing of adjusting shutter speed so as to obtain an image without blur according to the motion (speed) of a subject of the clipped image. The shutter speed is calculated according to the motion (speed) of the subject of the clipped image so as to obtain an image without blur, and the camera 10 is controlled to perform image capturing at the calculated shutter speed.

“(4) Blur amount control” is processing of adjusting blur amount (aperture) in consideration of the distance between a main subject set as the tracking target and other subjects, for example so that the main subject of the clipped image stands out. An adjustment parameter of the blur amount (aperture) is calculated in consideration of the distance between the main subject and other subjects so that the main subject in the clipped image stands out, and the calculated parameter is set in the camera 10 to cause the camera 10 to execute image capturing.

Next, more specific processing examples of “(3) Shutter speed control” and “(4) Blur amount control” will be described.

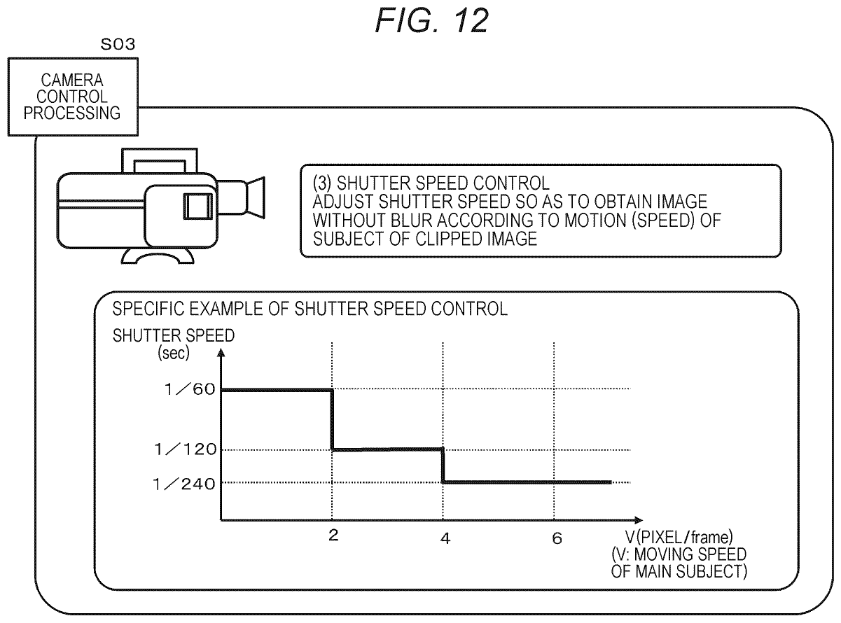

First, a specific processing example of “(3) Shutter speed control” will be described with reference to FIG. 12.

As described above, “(3) Shutter speed control” is processing of adjusting shutter speed so as to obtain an image without blur according to the motion (speed) of a subject of the clipped image.

The blur due to the motion of the subject is a phenomenon in which the captured image is blurred by the subject moving across a plurality of pixels during exposure.

In order to suppress the motion blur, the shutter speed (exposure time) of the camera 10 is increased so that the moving speed of the subject on the image being exposed, for example, the subject speed (pixel/frame) calculated as the moving pixel amount in one image frame does not exceed a predetermined threshold (set in advance according to the allowable degree of the blur amount). Note that, in general, the settable shutter speed is a discrete value in many cases.

However, when the shutter speed is excessively increased, smoothness as a video is lost, and when a phenomenon (riffling feeling) in which continuity of motion of a subject is lowered such as frame advance, what is called jerkiness, occurs in a reproduced video, the quality of the video is degraded, so that an upper limit of the shutter speed may be provided. Since there is a trade-off relationship between the motion blur and the jerkiness, it is preferable to adjust the motion blur and the jerkiness while seeing the balance therebetween.

The graph illustrated in FIG. 12 is a graph illustrating a specific example of the shutter speed control of the camera (60 fps) in which the camera 10 captures an image of 60 frames per second.

The vertical axis represents the shutter speed, and the horizontal axis represents the moving speed V (pixel/frame) calculated from the moving amount per frame of the main subject in the clipped image.

For example, when the moving speed of the main subject is 2 pixels/frame or less, the shutter speed is set to 1/60 (sec).

Furthermore, when the moving speed of the main subject is 2 to 4 pixels/frame, the shutter speed is set to 1/120 (sec).

Moreover, when the moving speed of the main subject is 4 pixels/frame or more, the shutter speed is set to 1/240 (sec).

As described above, when the moving speed of the main subject is 2 pixels/frame or less, the shutter speed is set to 1/60 (sec). In this case, the exposure time of one image frame in the camera that captures images of 60 frames per second (60fps) is 1/60 (sec), and the exposure of the next frame is immediately started after the exposure of one image frame.

Furthermore, when the moving speed of the main subject is 2 to 4 pixels/frame, the shutter speed is set to 1/120 (sec). In this case, the exposure time of one image frame in the camera that captures images of 60 frames per second (60 fps) is 1/120 (sec), and the exposure of the next frame is started after 1/120 (sec) elapses after the exposure of one image frame.

Moreover, when the moving speed of the main subject is 4 pixels/frame or more, the shutter speed is set to 1/240 (sec). In this case, the exposure time of one image frame in the camera that captures images of 60 frames per second (60 fps) is 1/240 (sec), and the exposure of the next frame is started after 3/240 (sec) elapses after the exposure of one image frame.

For example, the shutter speed is controlled according to the moving speed of the main subject in the clipped image in this manner.

By performing such shutter speed control, it is possible to capture a clear image without blur the main subject in the clipped image.

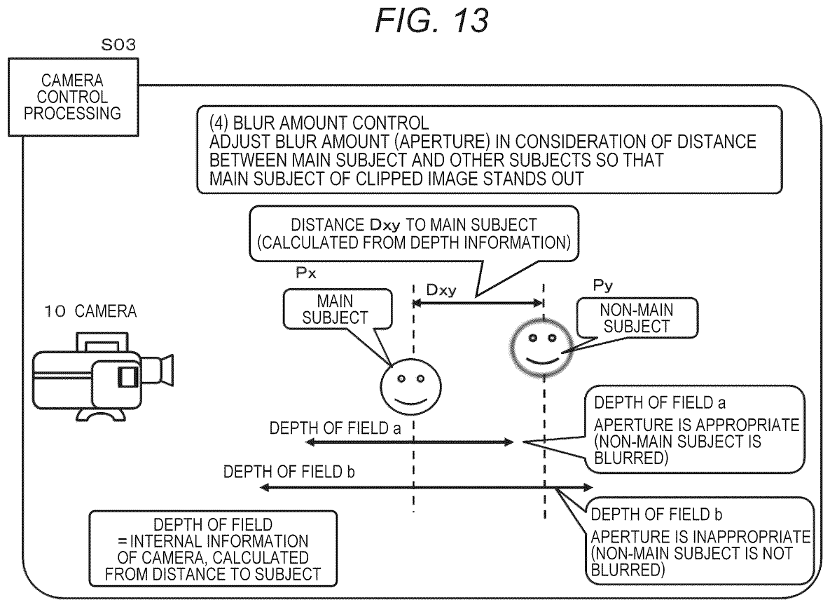

Next, a specific processing example of “(4) Blur amount control” will be described with reference to FIG. 13.

As described above, “(4) Blur amount control” is processing of adjusting blur amount (aperture) in consideration of the distance between a main subject set as the tracking target and other subjects, for example so that the main subject of the clipped image stands out.

The adjustment parameter of the blur amount (aperture) is calculated in consideration of the distance between the main subject and other subjects so that the main subject in the clipped image stands out, and the calculated parameter is set in the camera 10 to cause the camera 10 to execute image capturing.

“(4) Blur amount control” is executed for the purpose of blurring a “non-main subject” that is a subject other than the “main subject” in the clipped image so that the “main subject” in the clipped image stands out, for example.

FIG. 13 illustrates the camera 10, and a “main subject” Px and a “non-main subject” Py in the clipped image.

The distance between the main subject Px and the non-main subject Py is Dxy.

FIG. 13 further illustrates a “depth of field a” and a “depth of field b” as examples of setting two depths of field.

The depth of field is a range in which an image can be captured such that focus (focus) is on the image, and can be adjusted on the basis of an aperture value (F-number), a focal length, and an imaging distance (distance between a subject and a camera).

In the example illustrated in the drawing, in the setting of the “depth of field a”, since the focus (focus) is on the “main subject” Px but not on the “non-main subject” Py, only the “non-main subject” Py is captured in a blurred state.

On the other hand, in the setting of the “depth of field b”, the focus (focus) is on both of the “main subject” Px and the “non-main subject” Py, and both of the “main subject” Px and the “non-main subject” Py are captured in an unblurred state.

For example, in the camera control processing of step S03, as processing for blurring the “non-main subject” Py, the image processing device of the present disclosure calculates an adjustment value of the aperture (F-number) so that the “non-main subject” Py is out of the depth of field of the camera 10, and sets the calculated aperture (F-number) in the camera 10.

With this processing, it is possible to capture an image in which the “main subject” Px in the clipped image is in focus and the “non-main subject” Py is blurred.

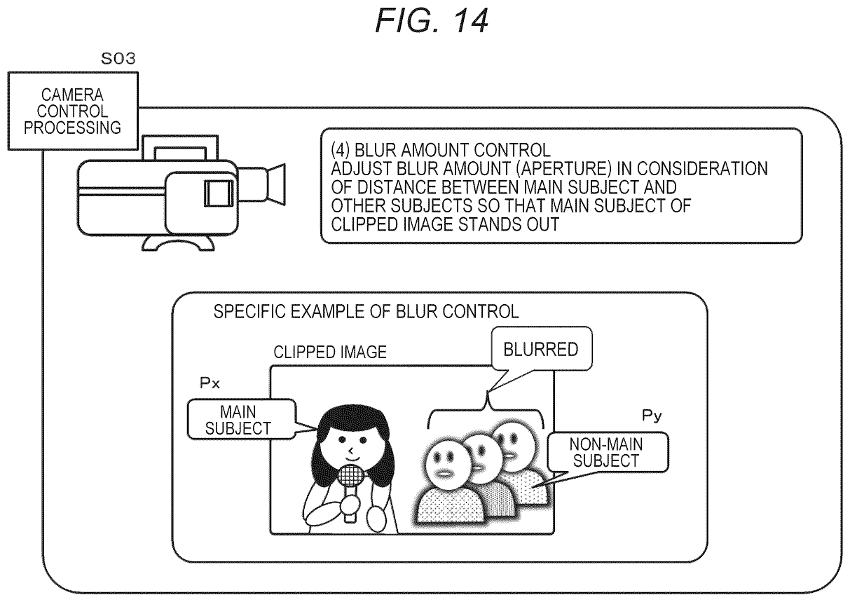

For example, as in the clipped image illustrated as a “specific example of blur control processing” in FIG. 14, it is possible to capture an image in which the “main subject” Px in the clipped image is in focus and the “non-main subject” Py is blurred, that is, an image in which the “main subject” Px is made conspicuous.

Note that the distance (depth information) between the “main subject” Px and the “non-main subject” Py is acquired by using a technology such as time of flight (ToF) or phase difference auto focus (AF).

Furthermore, the depth of field is calculated from an internal parameter of the camera 10.

In a case where the focal length or the camera position is fixed, the depth of field can be adjusted by controlling the aperture value (F-number).

Note that allowable circle of confusion that determines how much the subject is blurred is defined by setting an appropriate value in advance.

As described with reference to FIGS. 7 to 14, the image processing device of the present disclosure sequentially and repeatedly executes the three pieces of processing illustrated in FIG. 7, that is, the following three pieces of processing.
Step S01=image analysis processing
Step S02=image clipping processing
Step S03=camera control processing

The camera control parameters set in step S03, that is, the camera control parameters such as the focus, the exposure, the white balance (WB), the shutter speed, and the aperture (blur amount) are adjusted to the parameters optimum for the clipped image generated in step S02 by capturing an image with the camera while repeatedly executing these pieces of processing.

As a result of this processing, the clipped image to be distributed, displayed, or recorded in the storage unit becomes an image captured under the settings of the camera control parameters optimum for the clipped image, and it is possible to distribute, display, or record a clipped image with high quality.

### 3. Processing Example using PTZ Camera

Next, a processing example using a PTZ camera will be described as a second embodiment.

The above-described embodiment (first embodiment) has been described as an embodiment in which, when a clipped image obtained by clipping a partial region from a captured image by a camera is distributed, displayed, or recorded, the camera control parameters optimum for the clipped image, that is, the camera control parameters such as focus, exposure, white balance (WB), shutter speed, and aperture (blur amount) are set.

The processing of the present disclosure is not limited to the configuration in which such a clipped image is generated and distributed, and is also applicable to a configuration in which image clipping is not performed.

For example, in a case where an image is captured using a PTZ camera capable of sequentially changing an image capturing region by panning, tilting, zooming, or the like, the captured image is sequentially changed by pan, tilt, and zoom control. In such image capturing using the PTZ camera, by applying the processing of the present disclosure, it is possible to sequentially set the camera control parameters optimum for the captured image according to the change of the captured image region.

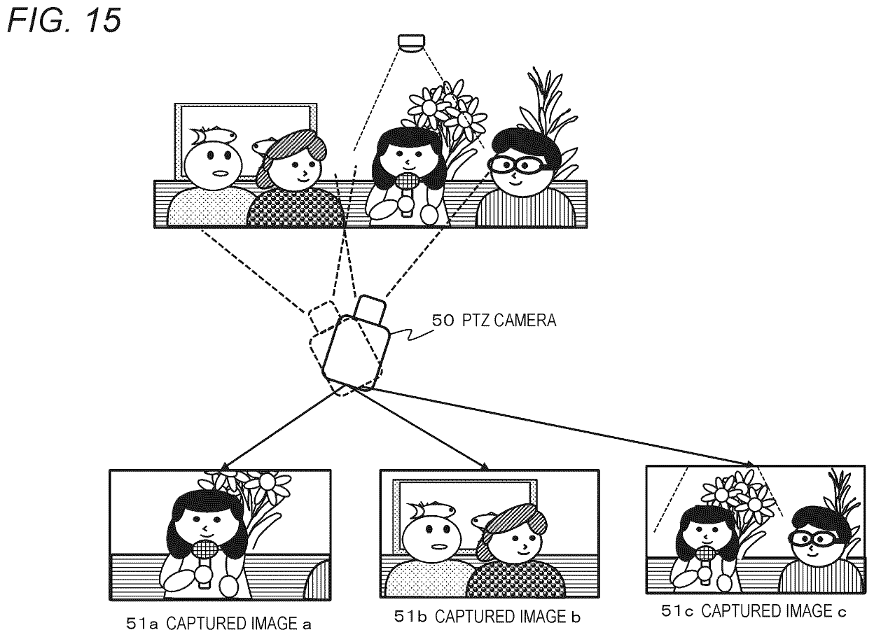

For example, as illustrated in FIG. 15, in a case where image capturing is performed using a PTZ camera 50, the captured image is sequentially changed by pan, tilt, and zoom control with respect to the PTZ camera 50.

As a result, for example, a captured image a, 51a to a captured image c, 51c with various angles of view illustrated in the lower part of FIG. 15 are captured.

The captured image a, 51a to the captured image c, 51c are different from each other in a captured image region, that is, an angle of view (field of view), and the optimum camera control parameters are also different according to the captured image region.

By applying the processing of the present disclosure, it is possible to calculate and set the optimum camera control parameters corresponding to each image captured by the PTZ camera 50.

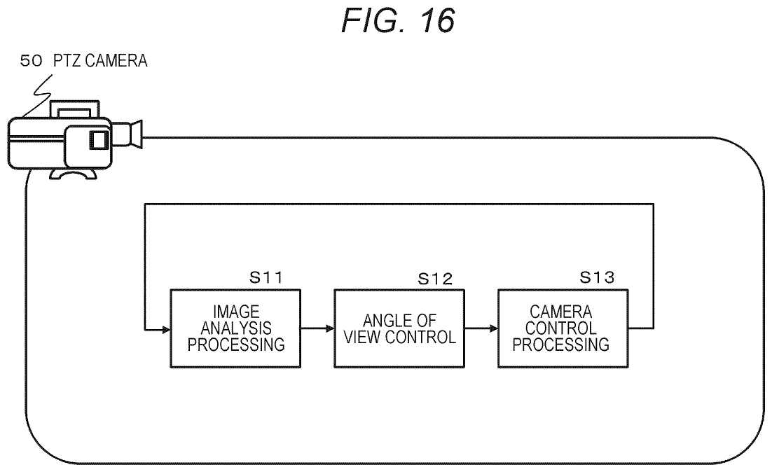

FIG. 16 is a diagram illustrating a processing sequence in a case where the PTZ camera 50 is used. As illustrated in FIG. 16, the PTZ camera 50 sequentially and repeatedly executes the following three pieces of processing.
Step S11=image analysis processing
Step S12=angle of view control
Step S13=camera control processing

“Step S11=image analysis processing” and “step S13=camera control processing” illustrated in FIG. 16 correspond to the processing of step S01 and step S03 in FIG. 7 described above.

That is, the processing sequence illustrated in FIG. 16 is a processing sequence including the three processing steps illustrated in FIG. 7 described above, that is,
Step S01=image analysis processing
Step S02=image clipping processing
Step S03=camera control processing,
in which “step S02=image clipping processing” is changed to “step S12=angle of view control” among these three steps. In step S02 in FIG. 7, the image clipping processing is performed by the camera 100 electronically performing panning, tilting, and zooming, but in step S12 in FIG. 16, the angle of view is controlled by the PTZ camera 50 physically performing panning, tilting, and zooming.

The image analysis processing in step S11 illustrated in FIG. 16 is analysis processing the captured image captured by the PTZ camera 50, the captured image being captured on the basis of the pan, tilt, and zoom settings at the latest timing.

The angle of view control in step S12 is processing of physically performing pan, tilt, and zoom settings (changes) of the PTZ camera 50 so that the angle of view based on the image analysis result in step S11 is obtained.

For example, the pan, tilt, and zoom setting (changing) processing is executed so that the angle of view including a face region, an upper body region, or an entire body region of a person set as the tracking target is obtained. As the pan, tilt, and zoom settings (changes), for example, the PTZ camera 50 controls a drive position (rotation angle with respect to the reference position) in the horizontal direction (pan direction) of the lens with which the PTZ camera 50 captures an image, controls a drive position (rotation angle with respect to the reference position) in the vertical direction (tilt direction) of the lens, controls a position (zoom magnification) at which the zoom lens of the PTZ camera 50 is moved in the optical axis direction, and controls a drive speed of the lens related to the pan, tilt, and zoom settings.

The camera control processing in step S13 is a step of calculating the camera control parameters optimum for the captured image captured on the basis of the latest pan, tilt, and zoom settings set in step S12, setting the calculated camera control parameters in the camera 10, and causing the camera 10 to execute image capturing.

When the processing of step S12 is completed, the processing of steps S11 to S13 is repeatedly executed for the next processed image frame to be captured by the PTZ camera 50.

Note that, when the pan, tilt, and zoom settings are different, the image region of the captured image is different, and thus, the optimum camera control parameters are also different.

In step S13, the camera control parameters optimum for the latest captured image that is newly set in step S13 is calculated.

The latest calculated camera control parameters are sequentially set in the PTZ camera 50, and the next image capturing is executed.

With these pieces of processing, even in a case where images with different pan, tilt, and zoom settings are captured, it is possible to set the camera control parameters optimum for each captured image in real time, and it is possible to capture an image with high image quality.

### 4. Configuration Example of Image Processing Device of Present Disclosure

Next, a configuration example of the image processing device of the present disclosure will be described.

As described above with reference to FIG. 7, an example of the image processing device of the present disclosure is, for example, the camera such as the camera 10 described above with reference to FIG. 1. However, the image processing device of the present disclosure is not limited to the camera, and can be configured as various devices such as a PC, a server, and a broadcasting device that perform processing by receiving a captured image by the camera as an input. Specific examples thereof will be described below.

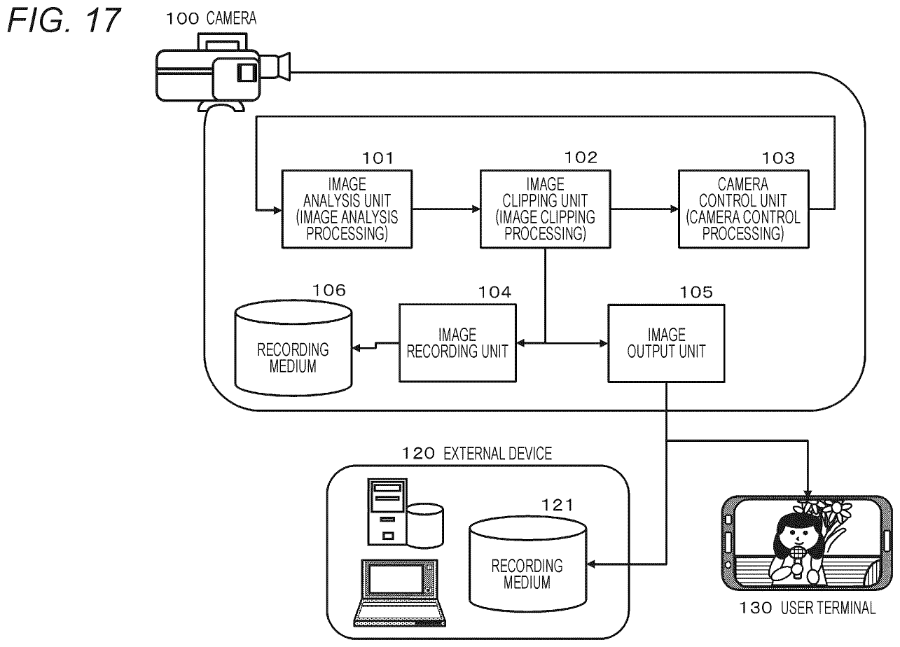

FIG. 17 is a diagram illustrating a configuration example of a camera 100, which is an example of the image processing device of the present disclosure.

The camera 100 includes an image analysis unit 101, an image clipping unit 102, a camera control unit 103, an image recording unit 104, an image output unit 105, and a recording medium 106.

Each of the image analysis unit 101, the image clipping unit 102, and the camera control unit 103 is a processing unit that executes processing of the following three processing steps described above with reference to FIG. 7.
Step S01=image analysis processing
Step S02=image clipping processing
Step S03=camera control processing

The image analysis unit 101 executes analysis processing of a captured image captured by the camera 100. For example, detection of a person to be clipped, detection processing of a face region, and the like are executed.

Specifically, for example, the processing described above with reference to FIG. 8 is executed.

The image clipping unit 102 executes processing of clipping a partial image region of the captured image captured by the camera 100.

As described above, in the image clipping unit 102, the operator performs processing of determining an image clipping region and clipping the image region, and the like.

Alternatively, processing of clipping an image with a predetermined angle of view according to a prescribed algorithm is executed while detecting and tracking a specific person or the like by using the AI analysis using at least one of the machine learning model such as the deep neural network or the rule-based model.

Specifically, for example, the processing described above with reference to FIGS. 9 and 10 is executed.

The camera control unit 103 calculates camera control parameters optimum for the clipped image generated by the image clipping unit 102, sets the calculated camera control parameters in the camera 100, and causes the camera 100 to execute image capturing.

The camera control unit 103 executes, for example, the following camera control processing.
(1) Focus control
(2) Exposure, white balance (WB) control
(3) Shutter speed control
(4) Blur amount control

The camera control unit 103 calculates control parameters necessary for the above control, sets the calculated parameters in the camera 100, and causes the camera 100 to execute image capturing processing.

Note that the camera control parameters to be calculated are parameters optimum for the clipped image clipped by the image clipping unit 102.

As a result of this processing, the clipped image to be distributed, displayed, or recorded in the storage unit becomes an image captured under the settings of the camera control parameters optimum for the clipped image, and it is possible to distribute, display, or record a clipped image with high quality.

The image recording unit 104 stores the clipped image generated by the image clipping unit 102 in the recording medium 106.

The image output unit 105 outputs the clipped image generated by the image clipping unit 102 to the outside. For example, the clipped image is output to an external device 120 having a recording medium 121, and the external device 120 records the clipped image on the recording medium 121.

The image output unit 105 further executes processing of distributing the clipped image generated by the image clipping unit 102 to a user terminal 130 such as a smartphone or a television owned by the user.

The example illustrated in FIG. 17 is a configuration example in which the image processing of the present disclosure, that is, the following three pieces of processing described above with reference to FIG. 7 are executed in the camera 100.
Step S01=image analysis processing
Step S02=image clipping processing
Step S03=camera control processing

In addition to such a configuration example, a configuration in which a part of the above three pieces of processing is executed in an external device other than the camera 100 is also possible.

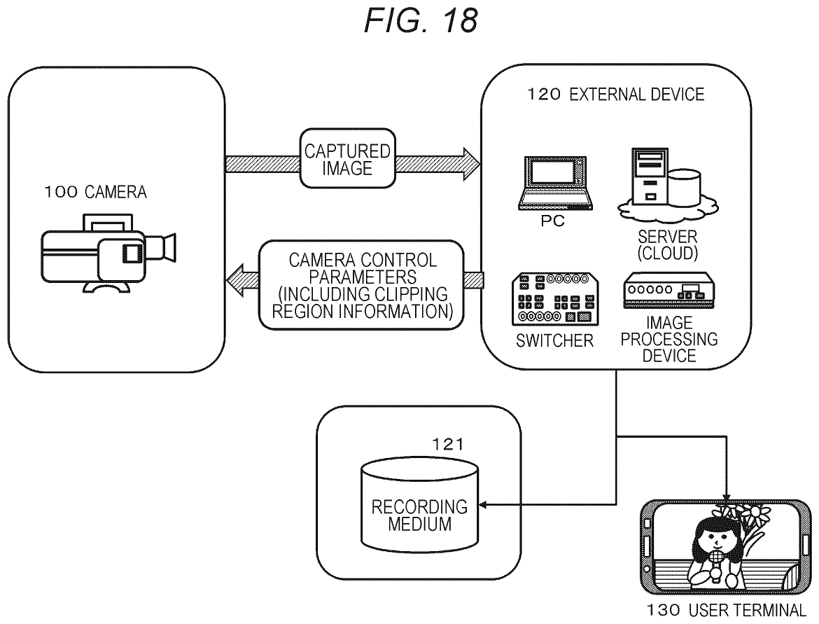

An example of such a configuration example will be described with reference to FIG. 18.

FIG. 18 illustrates the camera 100 and the external device 120. The camera 100 and the external device 120 have a communicable configuration.

The external device 120 includes, for example, at least one of a PC, a server (cloud), a switcher, other image processing devices, or the like.

The camera 100 captures an image (moving image) and transmits captured image data to the external device 120.

The external device 120 executes the following three pieces of processing described above with reference to FIG. 7 on the captured image received from the camera 100.
Step S01=image analysis processing
Step S02=image clipping processing
Step S03=camera control processing

The external device 120 calculates the camera control parameters generated by the above processing, that is, the control parameters optimum for the clipped image, and transmits the control parameters to the camera 100. The camera 100 executes image capturing in which the camera control parameters received from the external device 120 are set.

Note that the external device 120 also executes generation of the clipped image, and also transmits information regarding the clipping region (at least one of the position or the size of the clipping region) to the camera 100. Furthermore, the external device 120 transmits, to the camera 100, information indicating an image analysis result for the captured image received from the camera 100 in step S01 (for example, information regarding a feature of a subject recognized by image analysis and the position in the captured image) and information regarding the subject to be clipped (for example, identification information indicating a tracking target subject among the recognized subjects). The camera 100 can perform angle of view adjustment and the like for enabling an image of the clipping region to be captured on the basis of these pieces of information.

Note that, in the configuration illustrated in FIG. 18, the external device 120 executes the recording processing, the display processing, and the distribution processing of the clipped image.

The external device 120 stores and records the clipped image generated by the external device 120 in the recording medium 121.

Moreover, the external device 120 executes processing of distributing or displaying the generated clipped image to the user terminal 130 such as a smartphone or a television owned by the user.

Note that the image clipped by the camera 100 using clipping region information acquired from the external device 120 may be recorded in at least one of the image recording unit 104 or the recording medium 106 of the camera 100.

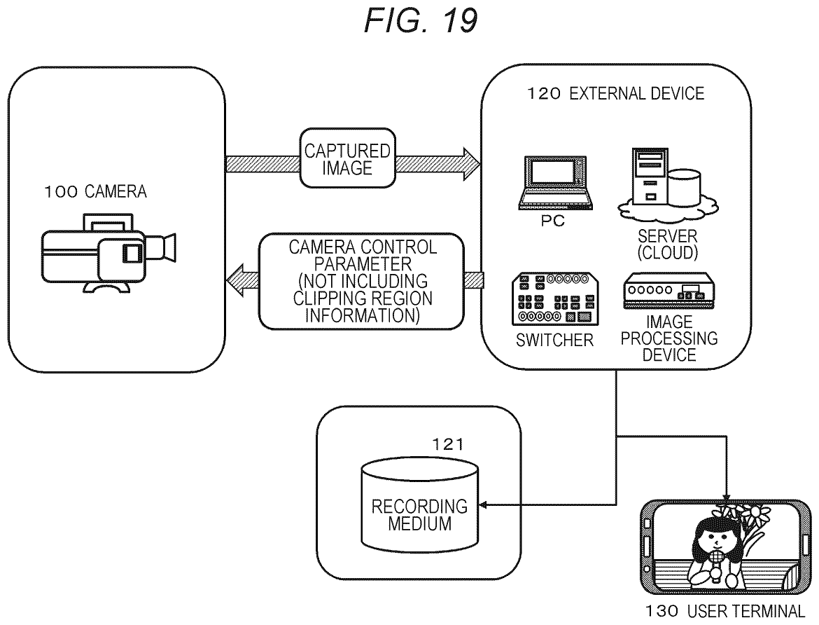

FIG. 19 is another configuration example of executing the processing of the present disclosure using the camera 100 and the external device 120, and is a processing configuration example different from that in FIG. 18.

Also in the configuration example illustrated in FIG. 19, the camera 100 captures an image (moving image) and transmits captured image data to the external device 120.

The external device 120 executes the following three pieces of processing described above with reference to FIG. 7 on the captured image received from the camera 100.
Step S01=image analysis processing
Step S02=image clipping processing
Step S03=camera control processing

The external device 120 calculates the camera control parameters generated by the above processing, that is, the control parameters optimum for the clipped image, and transmits the control parameters to the camera 100. The camera 100 executes image capturing in which the camera control parameters received from the external device 120 are set.

Also in the configuration illustrated in FIG. 19, the external device 120 generates a clipped image, but does not transmit, to the camera 100, the information regarding the clipping region, the information indicating the image analysis result, and the information regarding the subject to be clipped.

The camera 100 performs only processing of capturing a bird's-eye view image of a wide imaging range and transmitting the bird's-eye view image to the external device 120 without grasping the clipping region.

As described above with reference to FIGS. 17 to 19, the image processing of the present disclosure can be executed by the camera alone, or can be executed as cooperation processing between the camera and another external device.

### 5. Detailed Configuration of Image Processing Device of Present Disclosure

Next, a detailed configuration of the image processing device of the present disclosure will be described.

As described above, the image processing of the present disclosure can be executed by the camera alone, or can be executed as cooperation processing between the camera and another external device.

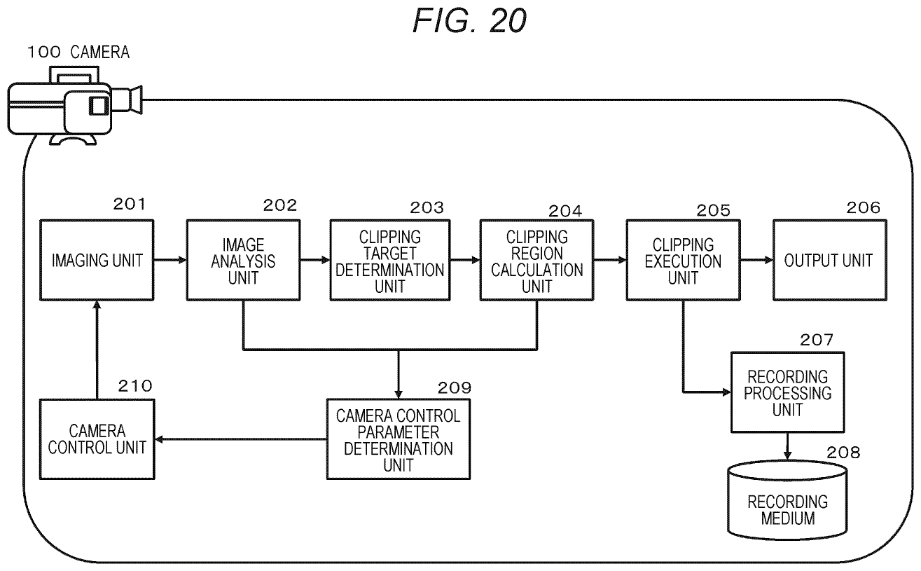

First, a configuration example of the image processing device, that is, the camera 100 in a case where the image processing of the present disclosure is executed by the camera alone will be described with reference to FIG. 20.

As illustrated in FIG. 20, the camera 100, which is an example of the image processing device of the present disclosure, includes an imaging unit 201, an image analysis unit 202, a clipping target determination unit 203, a clipping region calculation unit 204, a clipping execution unit 205, an output unit 206, a recording processing unit 207, a recording medium 208, a camera control parameter determination unit 209, and a camera control unit 210.

The imaging unit 201 executes image capturing processing. Note that the camera control parameters (focus, exposure, white balance (WB), shutter speed, aperture (blur amount), and the like) applied at the time of image capturing is automatically controlled by the camera control unit 210 so as to be optimum parameters for the entire captured image in the initial stage, but after the start of the image clipping processing, parameters determined by the camera control parameter determination unit 209 according to the clipped image is applied.

The image analysis unit 202 executes the image analysis processing in step S01 described above with reference to FIG. 7. That is, analysis processing of the captured image captured by the imaging unit 201 is executed. For example, detection of a person to be clipped, detection processing and tracking processing of a face region, and the like are performed.

Specifically, for example, the processing described above with reference to FIG. 8 is executed.

Note that the processing of the image analysis unit 202 to the camera control unit 210 is executed for each image frame input from the imaging unit 201 or for each predetermined plurality of image frames defined in advance as processing units.

As described above with reference to FIG. 8, the image analysis unit 202 executes the person detection processing by applying processing such as the face detection processing, the skeleton detection processing, and the segmentation processing, for example.

As described above, modes of the person detection processing include the detection processing of a head and a face region, the detection processing of an upper body, the detection processing of an entire body, and the like, and for example, the person detection processing is executed according to an algorithm determined in advance.

Note that the detection and tracking target is not limited to a person, and for example, processing of detecting and tracking an animal, an automobile, a musical instrument, a ball, or the like from a captured image may be performed as an analysis target.

Each of the clipping target determination unit 203, the clipping region calculation unit 204, and the clipping execution unit 205 executes the image clipping processing in step S02 described above with reference to FIG. 7.

The clipping target determination unit 203 determines at what angle of view a subject (for example, a person) is to be clipped, for example. This determination processing can be executed as processing in which the operator determines and clips an image clipping target and a region (GUI operation), or processing in which an image clipping target and a region are determined and an image with a predetermined angle of view is clipped according to a prescribed algorithm while detecting and tracking a specific person by using the AI analysis using at least one of the machine learning model such as the deep neural network or the rule-based model.

The clipping region calculation unit 204 executes processing of calculating a clipping region including the clipping target determined by the clipping target determination unit 203, for example, the position and the size of a clipping rectangular in the captured image.

The clipping execution unit 205 executes the image clipping processing from the captured image on the basis of the clipping region calculated by the clipping region calculation unit 204. Note that, in addition, processing of enlarging and reducing the clipped image to a predetermined image size defined in advance may be performed.

As described above, the clipping target determination unit 203, the clipping region calculation unit 204, and the clipping execution unit 205 execute the image clipping processing in step S02 described above with reference to FIG. 7, and specifically, for example, execute the image clipping processing described above with reference to FIGS. 9 and 10 to generate a clipped image and output the generated clipped image to the output unit 206 and the recording processing unit 207.

The clipping target determination unit 203, the clipping region calculation unit 204, and the clipping execution unit 205 execute processing of clipping an image region from the captured image, the image region including various objects (a person, an animal, a ball, and other various objects) detected in the image analysis processing executed by the image analysis unit 202.

The output unit 206 outputs the clipped image clipped by the clipping execution unit 205 to an external device and various user terminals such as a smartphone and a television.

The recording processing unit 207 records the clipped image clipped by the clipping execution unit 205 on the recording medium 208.

The camera control parameter determination unit 209 receives the analysis result of the captured image generated by the image analysis unit 202 and the clipping region information calculated by the clipping region calculation unit 204 as an input, and determines the camera control parameters optimum for the clipped image in the clipping image region on the basis of these pieces of input information.

The camera control parameters determined by the camera control parameter determination unit 209 include at least one of camera control parameters such as focus, exposure, white balance (WB), shutter speed, or aperture (blur amount).

The camera control parameters determined by the camera control parameter determination unit 209 are the optimum camera control parameters not for the entire image captured by the imaging unit 201, but for the clipped image included in the clipping region calculated by the clipping region calculation unit 204.

The camera control parameters determined by the camera control parameter determination unit 209 is input to the camera control unit 210.

The camera control unit 210 applies the camera control parameters input from the camera control parameter determination unit 209 to cause the imaging unit 201 to execute image capturing.

As a result, the camera 100 executes image capturing in which the optimum camera control parameters are applied to the clipped image.

The clipped image distributed via the output unit 206, the clipped image displayed, and the clipped image stored in the recording medium 208 are images captured under the settings of the camera control parameters optimum for the clipped image, so that it is possible to distribute, display, or record the clipped image with high image quality.

Note that the clipping target region determined by the clipping target determination unit 203 can be sequentially changed, and the clipping image region is also changed in accordance with this change. Furthermore, in accordance with this change, the camera control parameters determined by the camera control parameter determination unit 209 are also sequentially changed so as to be optimum for the clipped image after the change.

Note that when the clipping image region is changed, the camera control parameter determination unit 209 changes the camera control parameters so as to be optimum for the clipped image after the change, but as a parameter change processing mode, it is possible to select and execute one of the following two processing modes.
(a) The camera control parameters are changed simultaneously with image switching control timing.
(b) The camera control parameters are gradually changed in accordance with image switching control timing.

Any one of these pieces of camera control parameter change processing is executed.

The processing mode (b) is a processing mode for preventing the parameters from being suddenly changed and the image quality from being suddenly changed, and causing a smooth change of the image quality.

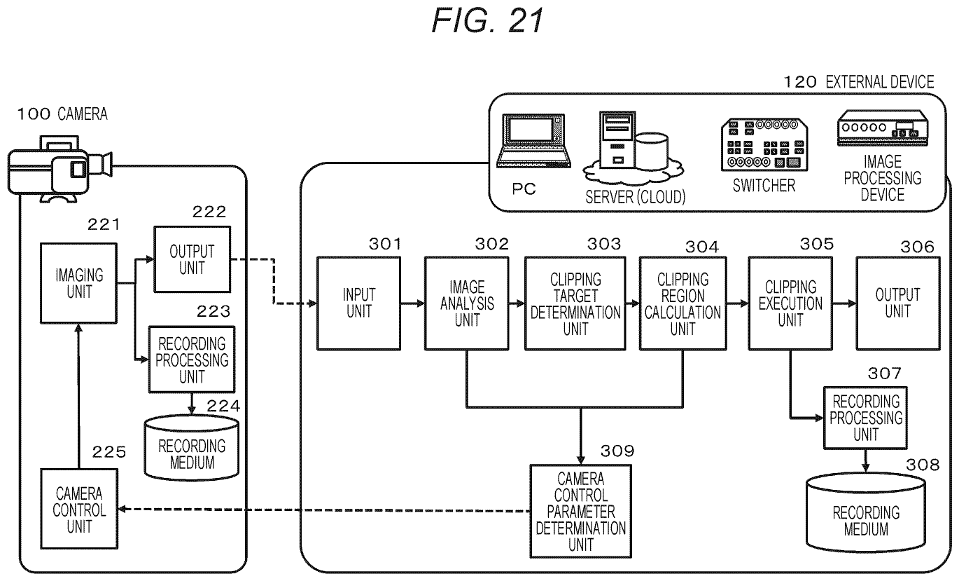

Next, configurations and processing of the camera 100 and the external device 120 in a case where the camera 100 and the external device 120 jointly execute the image processing of the present disclosure will be described with reference to FIG. 21 and subsequent drawings.

FIG. 21 is a diagram illustrating a configuration example of the camera 100 and the external device 120.

Note that the external device 120 includes, for example, at least one of a PC, a server (cloud), a switcher, a broadcasting device, other image processing devices, or the like.

Furthermore, the camera 100 and the external device 120 have a configuration capable of communicating with each other.

The camera 100 illustrated in FIG. 21 includes an imaging unit 221, an output unit 222, a recording processing unit 223, a recording medium 224, and a camera control unit 225.

Furthermore, the external device 120 includes an input unit 301, an image analysis unit 302, a clipping target determination unit 303, a clipping region calculation unit 304, a clipping execution unit 305, an output unit 306, a recording processing unit 307, a recording medium 308, and a camera control parameter determination unit 309.

The imaging unit 221 of the camera 100 executes image capturing processing. Note that the camera control parameters (focus, exposure, white balance (WB), shutter speed, aperture (blur amount), and the like) applied at the time of image capturing is automatically controlled by the camera control unit 225 so as to be optimum parameters for the entire captured image in the initial stage, but after the start of the image clipping processing, parameters determined by the camera control parameter determination unit 309 of the external device 120 according to the clipped image is applied.

The image captured by the imaging unit 221 is output to the external device 120 via the output unit 222 and recorded on the recording medium 224 via the recording processing unit 223.

The camera control unit 225 applies the camera control parameters input from the camera control parameter determination unit 309 of the external device 120 to cause the imaging unit 221 to execute image capturing.

With this processing, the camera 100 can execute image capturing in which the optimum camera control parameters are applied to the clipped image determined by the external device 120.

The input unit 301 of the external device 120 receives an image captured by the imaging unit 221 of the camera 100 from the output unit 222 of the camera 100 as an input and outputs the image to the image analysis unit 302.

The processing of the image analysis unit 302 to the camera control parameter 309 of the external device 120 is similar to the processing of the image analysis unit 202 to the camera control parameter 209 of the camera 100 described above with reference to FIG. 20.

In the configuration illustrated in FIG. 21, the external device 120 executes image analysis processing, that is, detection of a person or the like to be clipped. Moreover, the external device 120 also executes the image clipping processing. That is, for example, clipping processing of an image region including the detected person is executed.

Moreover, the external device 120 also executes determination processing of the camera control parameters optimum for image capturing of the clipped image.

Note that the camera control parameters determined by the camera control parameter determination unit 309 of the external device 120 include at least one of camera control parameters such as focus, exposure, white balance (WB), shutter speed, or aperture (blur amount).

The camera control parameters determined by the camera control parameter determination unit 309 of the external device 120 is input to the camera control unit 225 of the camera 100.

The camera control unit 225 of the camera 100 applies the camera control parameters input from the camera control parameter determination unit 309 of the external device 120 to cause the imaging unit 221 to execute image capturing.

As a result, the camera 100 can execute image capturing in which the optimum camera control parameters are applied to the clipped image clipped by the external device 120.

The clipped image distributed or displayed via the output unit 306 of the external device 120 or the clipped image stored in the recording medium 308 of the external device 120 is an image captured under the settings of the camera control parameters optimum for the clipped image generated in the external device 120, and it is possible to distribute, display, or record a clipped image with high quality.

Note that, also in the present example, the clipping target region determined by the clipping target determination unit 303 of the external device 120 can be sequentially changed, and the clipping image region is also changed in accordance with this change. Furthermore, in accordance with the change of the clipping image region, the camera control parameters determined by the camera control parameter determination unit 309 are also sequentially changed so as to be optimum for the clipped image after the change.

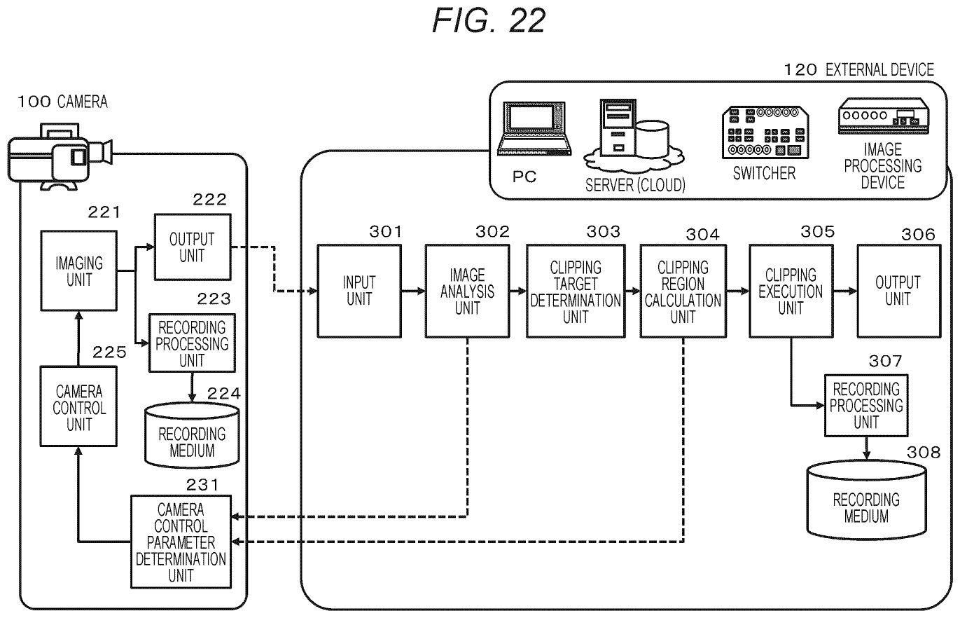

Similarly to FIG. 21, FIG. 22 is a diagram illustrating a configuration example in which the camera 100 and the external device 120 jointly execute the image processing of the present disclosure.

FIG. 22 is different from FIG. 21 in that the camera control parameter determination unit is provided on the camera side.

In the example illustrated in FIG. 22, the external device 120 includes, for example, at least one of a PC, a server (cloud), a switcher, a broadcasting device, other image processing devices, or the like.

Furthermore, the camera 100 and the external device 120 have a configuration capable of communicating with each other.

The camera 100 illustrated in FIG. 22 includes the imaging unit 221, the output unit 222, the recording processing unit 223, the recording medium 224, the camera control unit 225, and, moreover, a camera control parameter determination unit 231.

On the other hand, the external device 120 includes the input unit 301, the image analysis unit 302, the clipping target determination unit 303, the clipping region calculation unit 304, the clipping execution unit 305, the output unit 306, the recording processing unit 307, the recording medium 308.

The imaging unit 221 of the camera 100 executes image capturing processing. Note that the camera control parameters (focus, exposure, white balance (WB), shutter speed, aperture (blur amount), and the like) applied at the time of image capturing is automatically controlled by the camera control unit 225 so as to be optimum parameters for the entire captured image in the initial stage, but after the start of the image clipping processing, parameters determined by the camera control parameter determination unit 231 in the camera 100 according to the clipped image generated by the external device 120 is applied.

The image captured by the imaging unit 221 is output to the external device 120 via the output unit 222 and recorded on the recording medium 224 via the recording processing unit 223.

The camera control unit 225 applies the camera control parameters determined by the camera control parameter determination unit 231 in the camera 100 to cause the imaging unit 221 to execute image capturing.

Note that the camera control parameters determined by the camera control parameter determination unit 231 in the camera 100 are camera control parameters optimum for the clipped image generated by the external device 120.

With this processing, the camera 100 can execute image capturing in which the optimum camera control parameters are applied to the clipped image.

The input unit 301 of the external device 120 receives an image captured by the imaging unit 221 of the camera 100 from the output unit 222 of the camera 100 as an input and outputs the image to the image analysis unit 302.

The configurations and processing of the image analysis unit 302 to the recording medium 308 of the external device 120 are similar to the configurations and processing of the image analysis unit 202 to the recording medium 208 of the camera 100 described above with reference to FIG. 20.

In the configuration illustrated in FIG. 22, similarly to the configuration of FIG. 21, the external device 120 executes image analysis processing, that is, detection of a person or the like to be clipped. Moreover, the external device 120 also executes the image clipping processing. That is, for example, clipping processing of an image region including the detected person is executed.

However, in the configuration illustrated in FIG. 22, the external device 120 does not execute determination processing of the camera control parameters optimum for image capturing of the clipped image.

The camera control parameter determination unit 231 of the camera 100 executes determination processing of the camera control parameters optimum for image capturing of the clipped image.

The camera control parameter determination unit 231 of the camera 100 receives the analysis result of the captured image generated by the image analysis unit 302 of the external device 120 and the clipping region information calculated by the clipping region calculation unit 304 of the external device 120 as an input, and determines the camera control parameters optimum for the clipped image in the clipping image region on the basis of these pieces of input information.

The camera control parameters determined by the camera control parameter determination unit 231 of the camera 100 include at least one of camera control parameters such as focus, exposure, white balance (WB), shutter speed, or aperture (blur amount).

The camera control parameters determined by the camera control parameter determination unit 231 are the optimum camera control parameters not for the entire image captured by the imaging unit 221 of the camera 100, but for the clipped image included in the clipping region calculated by the clipping region calculation unit 304 of the external device 120.

The camera control parameters determined by the camera control parameter determination unit 231 of the camera 100 are input to the camera control unit 225.

The camera control unit 225 applies the camera control parameters input from the camera control parameter determination unit 231 to cause the imaging unit 221 to execute image capturing.

As a result, the camera 100 can execute image capturing in which the optimum camera control parameters are applied to the clipped image.

Note that, also in the configuration illustrated in FIG. 22, the clipped image distributed or displayed via the output unit 306 of the external device 120 or the clipped image stored in the recording medium 308 of the external device 120 is an image captured under the setting of the camera control parameters optimum for the clipped image generated in the external device 120, and it is possible to distribute, display, or record a clipped image with high quality.

Note that, also in the present example, the clipping target region determined by the clipping target determination unit 303 of the external device 120 can be sequentially changed, and the clipped image region is also changed in accordance with this change. Furthermore, in accordance with the change of the clipped image region, the camera control parameters determined by the camera control parameter determination unit 231 in the camera 100 is also sequentially changed so as to be optimum for the clipped image after the change.

### 6. Sequence of Processing Executed by Image Processing Device According to Present Disclosure

Next, a sequence of processing executed by the image processing device of the present disclosure will be described.

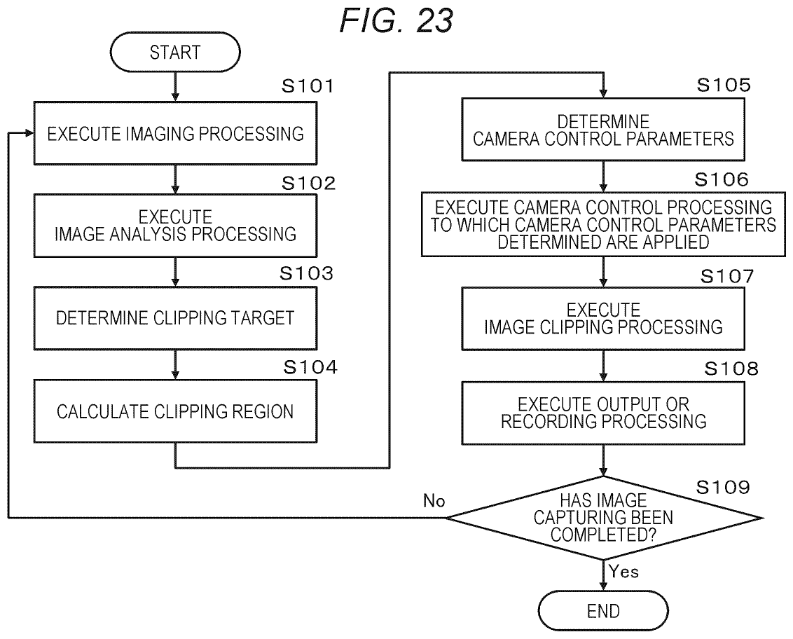

FIG. 23 is a flowchart illustrating a sequence of processing executed by the image processing device of the present disclosure.

Note that the processing according to the flowchart described below can be performed in accordance with, for example, a program stored in a storage unit of the image processing device under, for example, the control of a control unit having a program performance function such as a CPU or the like. Hereinafter, details of processing of each step of the flowchart illustrated in FIG. 23 will be sequentially described.

### (Step S101)

First, the image processing device of the present disclosure executes imaging processing, that is, image capturing processing in step S101.

Note that the image processing device of the present disclosure is, for example, a camera such as a television camera, and executes image capturing of a video (at least one of a moving image or a still image). That is, the camera is not limited to one that captures a moving image, and may be applied to one that captures a still image.

### (Step S102)

Next, the image processing device of the present disclosure executes image analysis processing in step S102.

This processing is processing executed by the image analysis unit 202 of the camera 100 illustrated in FIG. 20, for example, and corresponds to the image analysis processing in step S01 described above with reference to FIG. 7.

That is, analysis processing of the captured image captured by the imaging unit 201 of the camera 100 illustrated in FIG. 20 is executed. For example, detection of a person who is a subject of interest to be clipped (a tracking subject), detection processing and tracking processing of a face region, and the like are performed.

Specifically, for example, the processing described above with reference to FIG. 8 is executed.

Note that the processing of steps S102 to S109 is processing executed for each image frame captured by the imaging processing in step S101 or for each predetermined plurality of image frames defined in advance as processing units.

In step S102, processing such as the pattern matching, the face detection processing, the skeleton detection processing, and the segmentation processing is applied to execute the person detection processing and the like.

### (Step S103)

Next, the image processing device of the present disclosure executes determination processing of a clipping target in step S103.

This processing is, for example, processing executed by the clipping target determination unit 203 of the camera 100 illustrated in FIG. 20.

In step S103, at what angle of view a subject (for example, a person) to be clipped is determined, for example. This determination processing can be executed as processing in which the operator determines and clips an image clipping region (GUI operation), or processing in which an image with a predetermined angle of view is clipped according to a prescribed algorithm while detecting and tracking a specific person by using the AI analysis using at least one of the machine learning model such as the deep neural network or the rule-based model.

### (Step S104)

Next, the image processing device of the present disclosure executes determination processing of a clipping region in step S104.

This processing is, for example, processing executed by the clipping region calculation unit 204 of the camera 100 illustrated in FIG. 20.

The clipping region calculation unit 204 executes processing of calculating (position and size) a clipping region including the clipping target determined by the clipping target determination unit 203, for example, a clipping rectangular.

### (Step S105)

Next, the image processing device of the present disclosure executes camera control parameter determination processing in step S105.

This processing is processing executed by the camera control parameter determination unit 209 of the camera 100 illustrated in FIG. 20, for example.

In step S105, the image processing device of the present disclosure determines the camera control parameters optimum for the clipped image in the clipping image region by using the image analysis result acquired in the image analysis processing in step S102 and the clipping region information calculated in the clipping region calculation processing in step S104.

The camera control parameters determined in step S105 are parameters including at least one of camera control parameters such as focus, exposure, white balance (WB), shutter speed, or aperture (blur amount).

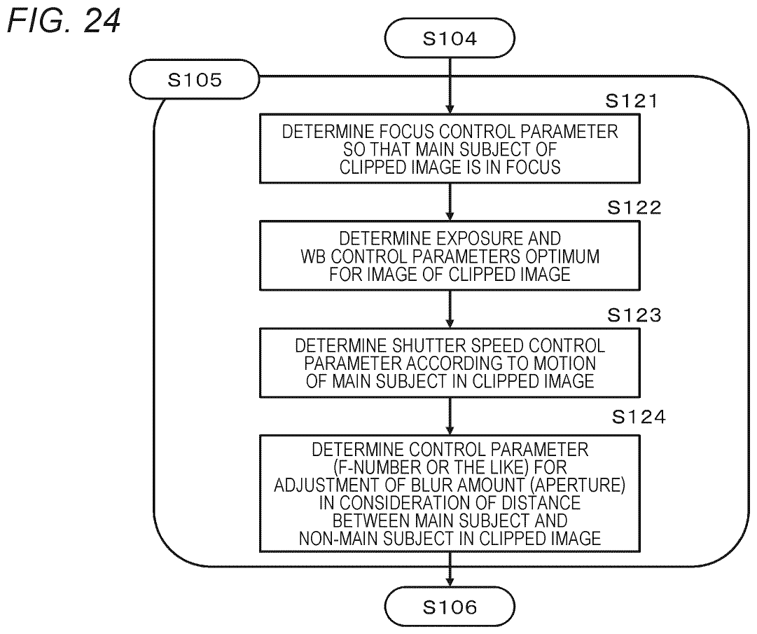

Note that a detailed sequence of the camera control parameter determination processing in step S105 will be described later with reference to FIG. 24.

### (Step S106)

Next, in step S106, the image processing device of the present disclosure executes the camera control processing to which the camera control parameters determined in step S105 are applied.

This processing is processing executed by the camera control unit 210 of the camera 100 illustrated in FIG. 20, for example.

In step S106, the image processing device of the present disclosure applies the camera control parameters (at least one of focus, exposure, white balance (WB), shutter speed, aperture (blur amount), or the like) determined in step S105 to cause the imaging unit to execute image capturing.

With this processing, the camera 100 executes image capturing in which the optimum camera control parameters are applied to the clipped image.

Note that, as described above, when the clipped image region is changed, the camera control parameters are also changed so as to be optimum for the clipped image after the change, but the camera control processing mode in a case where the parameters are changed can be configured to select and execute one of the following two processing modes.
(a) The camera control parameters are changed simultaneously with image switching control timing.
(b) The camera control parameters are gradually changed in accordance with image switching control timing.

Any one of these pieces of camera control parameter change processing is executed.

As described above, the processing mode (b) is a processing mode for preventing the parameters from being suddenly changed and the image quality from being suddenly changed, and causing a smooth change of the image quality.

### (Step S107)

Next, in step S107, the image processing device of the present disclosure executes the image clipping processing on the basis of the clipping region determined in step S104.

This processing is, for example, processing executed by the clipping execution unit 205 of the camera 100 illustrated in FIG. 20.

In step S107, the image processing device of the present disclosure executes the image clipping processing from the captured image on the basis of the image clipping region calculated in step S104. Note that, in addition, processing of enlarging and reducing the clipped image to a predetermined image size defined in advance may be performed.

### (Step S108)

Next, in step S108, the image processing device of the present disclosure executes at least one of output processing or recording processing of the clipped image clipped in step S107.

This processing is processing executed by the output unit 206 and the recording processing unit 207 of the camera 100 illustrated in FIG. 20, for example.

The output unit 206 outputs the clipped image clipped by the clipping execution unit 205 to an external device and various user terminals such as a smartphone and a television.

The recording processing unit 207 records the clipped image clipped by the clipping execution unit 205 on the recording medium 208.

The clipped image distributed or displayed via the output unit 206, and the clipped image stored in the recording medium 208 are images captured under the settings of the camera control parameters optimum for the clipped image, so that it is possible to distribute, display, or record the clipped image with high image quality.

### (Step S109)

Finally, the image processing device of the present disclosure determines in step S109 whether or not image capturing has been completed. In a case where image capturing has not been completed, the process returns to step S101, and the processing of step $101 and subsequent processing is repeated for the next captured image.

In a case where the image capturing has been completed, the process ends.

Next, an example of a detailed sequence of the camera control parameter determination processing in step S105 will be described with reference to the flowchart illustrated in FIG. 24.

As described above, the image processing device of the present disclosure executes camera control parameter determination processing in step S105.

In step S105, the camera control parameters optimum for the clipped image in the clipping image region are determined by using the image analysis result acquired in the image analysis processing in step S102 and the clipping region information calculated in the clipping region calculation processing in step S104. The camera control parameters to be determined are parameters including at least one of camera control parameters such as focus, exposure, white balance (WB), shutter speed, or aperture (blur amount).

FIG. 24 illustrates an example of a sequence of the camera control parameter determination processing in step S105.

The processing of each step of the flowchart illustrated in FIG. 24 will be sequentially described.

### (Step S121)

In step S121, the image processing device of the present disclosure determines a focus control parameter so that the main subject of the clipped image is in focus.

That is, the focus control parameter is determined so that the main subject of the clipped image is in focus by using the main subject to be the target of interest (tracking target) detected in step S102 described with reference to FIG. 23 and the clipping region information calculated in the clipping region calculation processing in step S104.

### (Step S122)

Next, in step S122, the image processing device of the present disclosure determines exposure and white balance (WB) control parameters optimum for the image of the clipped image.

That is, the exposure and white balance (WB) control parameter optimum for the image of the clipped image is determined so that the main subject of the clipped image is in focus by using the main subject to be the target of interest (tracking target) detected in step S102 described with reference to FIG. 23 and the clipping region information calculated in the clipping region calculation processing in step S104.

### (Step S123)

Next, in step S123, the image processing device of the present disclosure determines an optimum shutter speed control parameter according to the motion of the main subject in the clipped image.

That is, the optimum shutter speed control parameter according to the motion of the main subject in the clipped image is determined so that the main subject of the clipped image is in focus by using the main subject to be the target of interest (tracking target) detected in step S102 described with reference to FIG. 23 and the clipping region information calculated in the clipping region calculation processing in step S104.

Note that the specific example of the shutter speed control is as described above with reference to FIG. 12, and the processing of increasing the shutter speed is performed as the subject speed is faster.

As described above, the shutter speed control is control for suppressing motion blur.

The shutter speed (exposure time) of the camera is increased so that the moving speed of the subject on the image being exposed, for example, the subject speed (pixel/frame) calculated as the moving pixel amount in one image frame does not exceed a predetermined threshold (set in advance according to the allowable degree of the blur amount). Note that, in general, the settable shutter speed is a discrete value in many cases.

However, when the shutter speed is excessively increased, smoothness as an image is lost and riffling feeling is generated. Therefore, an upper limit of the shutter speed may be provided. Since the motion blur and the riffling feeling are trade-off, it is preferable to adjust the motion blur and the feeling of fogging while seeing the balance therebetween.

### (Step S124)

Next, in step S124, the image processing device of the present disclosure determines a control parameter (F-number or the like) for adjustment of the blur amount (aperture) in consideration of the distance between the main subject and the non-main subject in the clipped image.

That is, the control parameter (F-number or the like) for adjustment of the blur amount (aperture) in consideration of the distance between the main subject and the non-main subject in the clipped image is determined by using the main subject to be the target of interest (tracking target) detected in step S102 described with reference to FIG. 23 and the clipping region information calculated in the clipping region calculation processing in step S104.

This processing corresponds to the processing described above with reference to FIGS. 13 and 14.

As described above with reference to FIG. 13, as processing for blurring the “non-main subject” Py in the clipped image, the adjustment value of the aperture (F-number) is calculated so that the “non-main subject” Py is out of the depth of field of the camera.

By setting the parameter (F-number) calculated by this processing and performing image capturing, it is possible to capture an image in which the “main subject” Px in the clipped image is in focus and the “non-main subject” Py is blurred.

For example, as in the clipped image illustrated as the “specific example of blur control processing” in FIG. 14, it is possible to capture an image in which the “main subject” Px in the clipped image is in focus and the “non-main subject” Py is blurred, that is, an image in which the “main subject” Px is made conspicuous.

Note that, as described above, the distance (depth information) between the “main subject” Px and the “non-main subject” Py is acquired by ToF, phase difference AF, or the like.

Furthermore, the depth of field is calculated from an internal parameter of the camera.

In a case where the focal length or the camera position is fixed, the depth of field can be adjusted by controlling the aperture value (F-number).

Note that allowable circle of confusion that determines how much the subject is blurred is defined by setting an appropriate value in advance.

The processing of steps S121 to S124 of the flowchart illustrated in FIG. 24 is an example of a detailed sequence of the camera control parameter determination processing of step S105 of the flowchart illustrated in FIG. 23.

Note that the processing order of steps S121 to S124 of the flowchart illustrated in FIG. 24 is an example, and may be executed in another order or may be executed in parallel. Furthermore, processing of calculating a part of the camera control parameters may be executed by executing a part of the processing of steps S121 to S124.

### 7. Example of GUI Applicable to Designation Processing of Clipping Image Region and the Like

Next, an example of a GUI applicable to designation processing of a clipping image region and the like will be described.

As described above, processing by the operator, detection and tracking processing of a specific subject by the AI analysis, or the like can be performed on which region is to be clipped from the captured image by the camera.

Hereinafter, an example of a graphical user interface (GUI) that can be used when the operator determines which region is to be clipped from the captured image by the camera and inputs the determined information will be described.

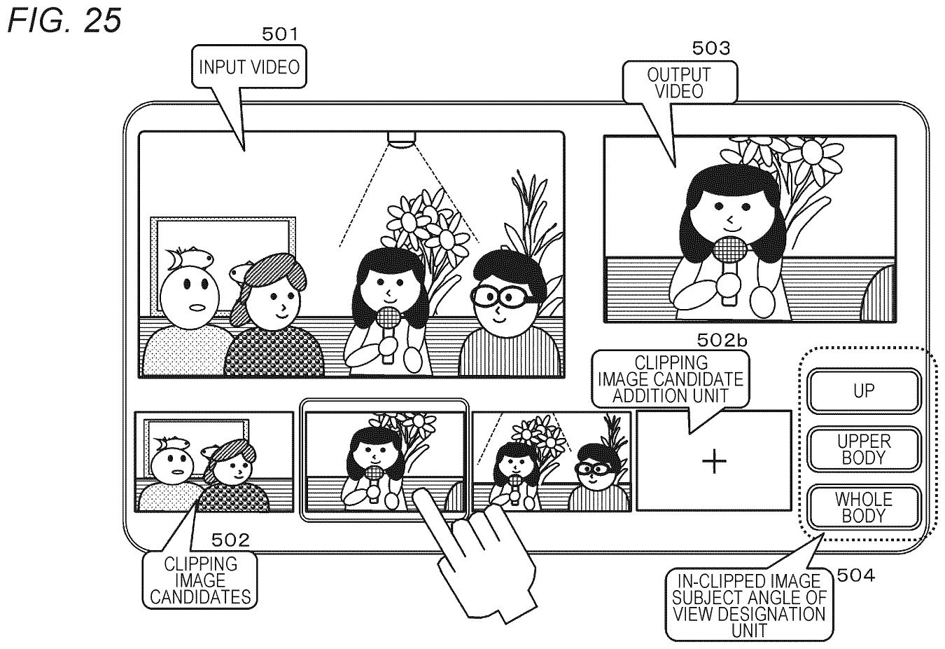

FIG. 25 is a diagram illustrating an example of a GUI output to the display unit of the image processing device of the present disclosure.

As illustrated in FIG. 25, the GUI includes each data display region of an input video 501, clipping image candidates 502, a clipping image candidate addition unit 502b, an output video 503, and an in-clipped image subject angle of view designation unit 504.

The input video 501 is the entire image captured by the imaging unit of the camera.

The clipping image candidates 502 is, for example, an image individually including a region or including a plurality of regions of a person as a subject included in the input video 501, and is a region in which clipping image candidates generated according to a predetermined algorithm are displayed side by side.

The clipping image candidate addition unit 502b additionally displays, as a clipping candidate, an image in a rectangular region generated by an operator operating on the input video 501, for example.

The output video 503 is a region in which a clipped image to be finally distributed externally, displayed, or recorded on a recording medium is displayed.

The in-clipped image subject angle of view designation unit 504 is, for example, an operation unit used when the operator selects a subject region to be included in the clipped image.

The example illustrated in the drawing illustrates an operation unit capable of selecting three types of subject regions of “up”, “upper body”, and “whole body”. This is merely an example, and various operation units can be displayed.

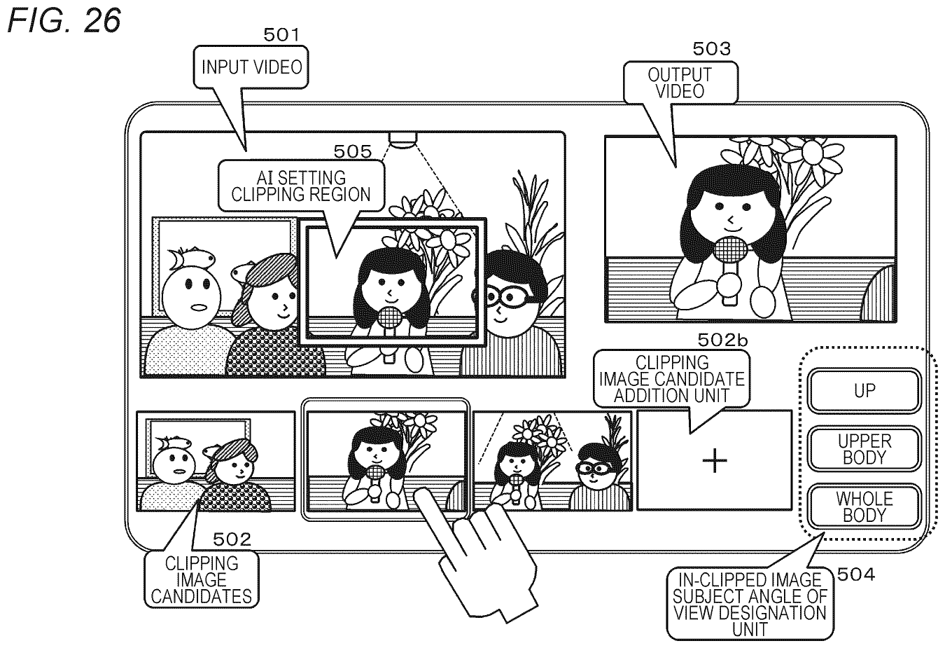

Furthermore, for example, in a case where detection and tracking processing of a specific subject by the AI analysis, or the like is performed, and image clipping is performed using the AI analysis result, as illustrated in FIG. 26, an “AI setting clipping region” 505 may be displayed in the input video 501.

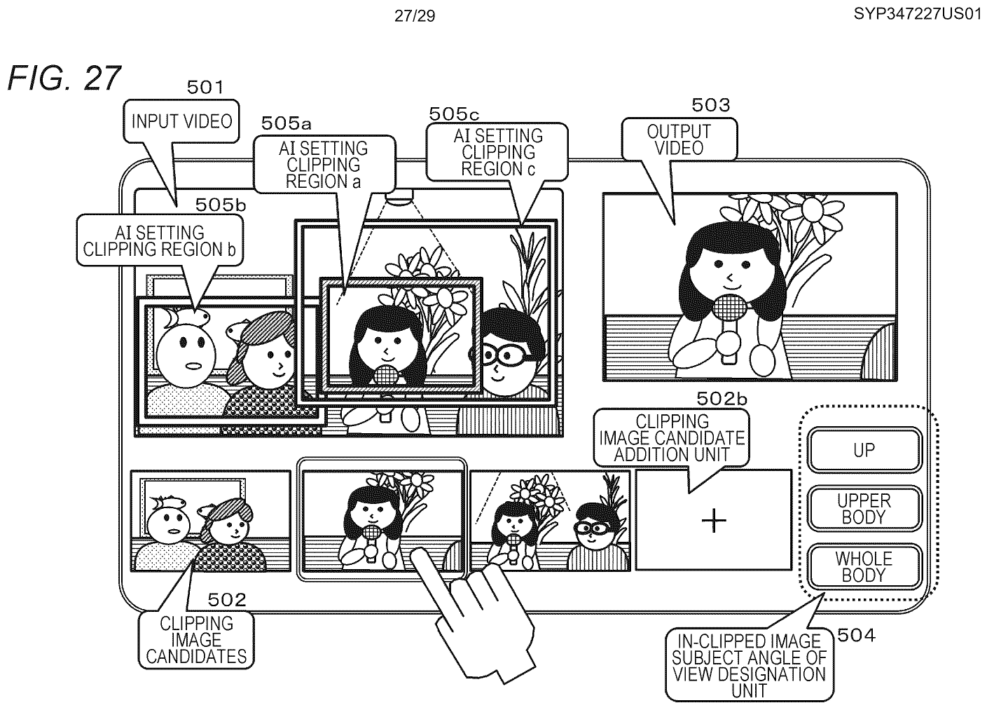

Moreover, as illustrated in FIG. 27, a plurality of “AI setting clipping regions” 505a to 505c may be displayed, and freely selected by the operator. The selected clipping image region is clearly indicated, for example, by changing the color of the frame of the region selected by the operator. In FIG. 27, the color of the frame of the AI setting clipping region 505a selected by the operator is indicated by a color (hatched line in FIG. 27) different from the colors of the frames of the AI setting clipping region 505b and the AI setting clipping region 505c.

A plurality of clipping image candidates determined by the operator or the AI processing unit is displayed as the clipping image candidates 502.

One clipped image determined as the output image by the operator or the AI processing unit is displayed as the output video 503.

Note that the initial image of the output video 503 is the entire captured image similar to that of the input video 501.

In a case of performing processing (registration processing) of registering a new clipping image as a clipping image candidate, the operator performs, for example, the following operation.

First, any clipping region is set in the input video 501, and the clipping image candidate addition unit 502b is touched. With this processing, a new clipping image candidate is added.

Moreover, the main subject can be selected by selecting the face frame of the subject in a state where the new clipping image is set as the clipping image candidate. One person, a plurality of persons, and an object can be set as the main subject.

Moreover, at what angle of view (size, presence or absence of front space, presence or absence of telop region, and the like) the selected target subject is to be clipped can be selected and set by “angle of view designation”.

Finally, the registration processing state is ended by touching the clipping image candidate under the registration processing.

Furthermore, in a case where the operator (person) executes switching of the output video 503, the following processing is performed.

First, the operator selects (click, tap, or the like) the output video. With this processing, the state proceeds to an output video switching state.

Next, in this output video switching state, one image of the clipping image candidates 502 is selected (click, tap, or the like). With this processing, the output video 503 is switched.

Finally, the output video 503 is selected (click, tap, or the like) to end the output video switching state.

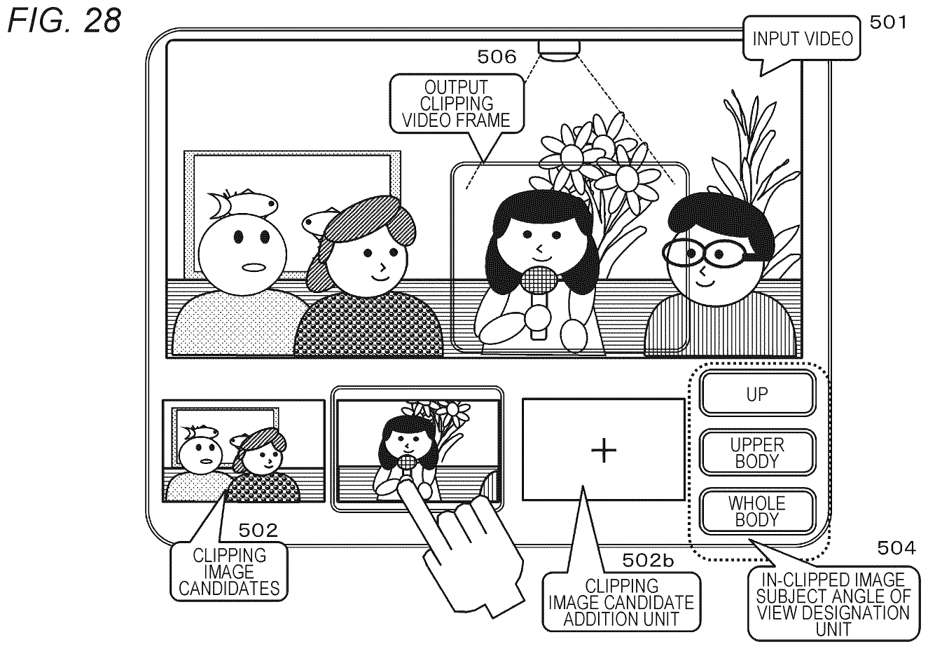

FIG. 28 is a simplified GUI in which the display region of the output video is deleted. In this example, an output clipping video frame 506 indicating the region of the output image selected by the operator or the like is displayed inside the input video 501.

### 8. Hardware Configuration Example of Image Processing Device

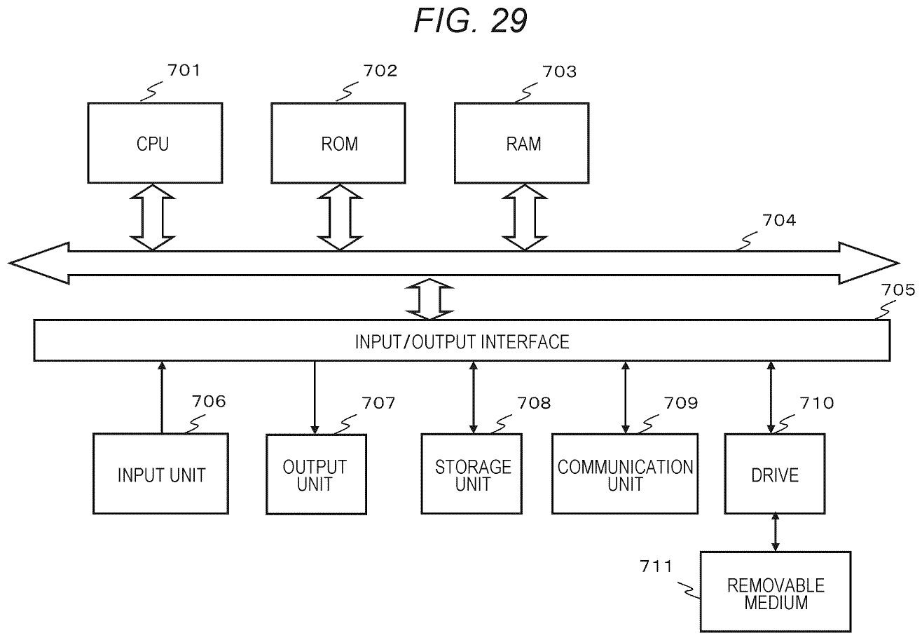

Next, a hardware configuration example of the image processing device that executes the processing according to the above-described embodiment will be described with reference to FIG. 29.

The hardware illustrated in FIG. 29 is an example of a hardware configuration of the camera and the external device described above with reference to FIGS. 20 to 23, for example.

The hardware configuration illustrated in FIG. 29 will be described.

A central processing unit (CPU) 701 functions as a data processing unit configured to execute various types of processing in accordance with a program stored in a read only memory (ROM) 702 or a storage unit 708. For example, the CPU 701 executes the processing according to the sequence described in the above-described embodiment. A random access memory (RAM) 703 stores a program executed by the CPU 701, data, and the like. The CPU 701, the ROM 702, and the RAM 703 are connected to each other by a bus 704.

The CPU 701 is connected to an input/output interface 705 via the bus 704, and an input unit 706 including various sensors, a camera, a switch, a keyboard, a mouse, a microphone, and the like, and an output unit 707 including a display, a speaker, and the like are connected to the input/output interface 705.

The storage unit 708 connected to the input/output interface 705 includes, for example, a hard disk, and the like and stores programs executed by the CPU 701 and various data. A communication unit 709 functions as a data communication transmitting/receiving unit via a network such as the Internet or a local area network, and communicates with an external device.

A drive 710 connected to the input/output interface 705 drives a removable medium 711 such as a magnetic disk, an optical disc, a magneto-optical disk, or a semiconductor memory such as a memory card to record or read data.

### 9. Summary of Configuration of Present Disclosure

The embodiments of the present disclosure have been described above in detail with reference to specific embodiments. However, it is obvious that those skilled in the art can modify or substitute the embodiments without departing from the gist of the present disclosure. That is, the present invention has been disclosed in the form of exemplification, and should not be interpreted in a limited manner. In order to determine the gist of the present disclosure, the claims should be considered.

Note that the technology disclosed herein may have the following configurations.

(1) The image processing device including:
a clipping execution unit that generates a clipped image obtained by clipping a partial region from a captured image by a camera;
a camera control parameter determination unit that determines a camera control parameter optimum for the clipped image; and
a camera control unit that causes the camera to execute image capturing to which the camera control parameter determined by the camera control parameter determination unit is applied.

(2) The image processing device according to (1),
in which the camera control parameter determination unit determines a camera control parameter of at least one of focus, exposure, white balance (WB), shutter speed, or aperture optimum for the clipped image.

(3) The image processing device according to (1) or (2),
further including an image analysis unit that executes analysis processing of a captured image by the camera,
in which the image analysis unit executes detection processing of a subject to be included in the clipped image from the captured image by the camera.

(4) The image processing device according to (3),
in which the image analysis unit executes detection processing of a person or detection processing of a face region to be included in the clipped image.

(5) The image processing device according to (3) or (4),
in which the clipping execution unit generates a clipped image including a subject detected by the image analysis unit.

(6) The image processing device according to any one of (3) to (5),
in which the clipping execution unit generates a clipped image including a person region or a face region detected by the image analysis unit.

(7) The image processing device according to any one of (1) to (6),
in which the image analysis unit includes a clipping target determination unit that determines a subject to be included in a clipped image generated by the clipping execution unit, and
the clipping target determination unit executes processing of determining at what angle of view a subject to be clipped is to be clipped.

(8) The image processing device according to (7),
in which the clipping target determination unit executes
clipping target determination processing by an operator or clipping target determination processing using AI analysis.

(9) The image processing device according to (7) or (8),
in which the clipping target determination unit executes clipping target determination processing by using AI analysis using at least one of a machine learning model or a rule-based model.

(10) The image processing device according to any one of (1) to (9),
in which the image analysis unit includes a clipping region calculation unit that calculates a clipping image region of a clipped image generated by the clipping execution unit, and
the clipping region calculation unit calculates a position and a size of the clipped image in the captured image.

(11) The image processing device according to any one of (1) to (10),
in which the camera control parameter determination unit determines a focus control parameter so that a main subject of the clipped image is in focus.

(12) The image processing device according to any one of (1) to (11),
in which the camera control parameter determination unit determines control parameters of exposure and white balance (WB) optimum for an image of the clipped image.

(13) The image processing device according to any one of (1) to (12),
in which the camera control parameter determination unit determines an optimum shutter speed control parameter according to motion of a main subject in the clipped image.

(14) The image processing device according to any one of (1) to (13),
in which the camera control parameter determination unit determines a control parameter for aperture adjustment in consideration of a distance between a main subject and a non-main subject in the clipped image.

(15) The image processing device according to (14),
in which the control parameter for aperture adjustment is an F-number.

(16) The image processing device according to any one of (1) to (15),
further including a display unit that displays a GUI including a display region of a captured image by the camera and a clipping image candidate display region for displaying a candidate image of a clipped image,
in which the GUI is a GUI that enables selection of a clipped image to be output from among a plurality of clipping image candidates displayed in the clipping image candidate display region.

(17) An image processing method executed in an image processing device, the method executing:
an image clipping step of generating, by a clipping execution unit, a clipped image obtained by clipping a partial region from a captured image by a camera;
a camera control parameter determination step of determining, by a camera control parameter determination unit, a camera control parameter optimum for the clipped image; and
a camera control step of causing, by a camera control unit, the camera to execute image capturing to which the camera control parameter determined in the camera control parameter determination step is applied.

(18) A program for causing an image processing device to execute image processing, the program causing the image processing device to execute:
an image clipping step of causing a clipping execution unit to generate a clipped image obtained by clipping a partial region from a captured image by a camera;
a camera control parameter determination step of causing a camera control parameter determination unit to determine a camera control parameter optimum for the clipped image; and
a camera control step of causing a camera control unit to execute causing the camera to execute image capturing to which the camera control parameter determined in the camera control parameter determination step is applied.

Furthermore, a series of processing described herein can be executed by hardware, software, or a configuration obtained by combining hardware and software. In a case of processing by software is executed, a program in which a processing sequence is recorded can be installed and performed in a memory in a computer incorporated in dedicated hardware, or the program can be installed and performed in a general-purpose computer capable of executing various types of processing. For example, the program can be recorded in advance in a recording medium. In addition to being installed in a computer from the recording medium, a program can be received via a network such as a local area network (LAN) or the Internet and installed in a recording medium such as an internal hard disk or the like.

Note that the various types of processing described herein may be executed not only in a chronological order in accordance with the description, but may also be executed in parallel or individually depending on processing capability of a device that executes the processing or depending on the necessity.

Furthermore, a system herein described is a logical set configuration of a plurality of devices, and is not limited to a system in which devices of respective configurations are in the same housing.

### Industrial Applicability

As described above, according to the configuration of an embodiment of the present disclosure, it is possible to generate an image captured with a camera control parameter optimum for a clipped image of a partial region of a captured image by a camera, and to distribute, display, or record the image.

Specifically, for example, the image processing device includes: a clipping execution unit that generates a clipped image obtained by clipping a partial region from a captured image by a camera; a camera control parameter determination unit that determines a camera control parameter optimum for the cut-out image; and a camera control unit that causes the camera to execute image capturing to which the camera control parameter determined by the camera control parameter determination unit is applied. The camera control parameter determination unit determines a camera control parameter of at least one of focus, exposure, white balance (WB), shutter speed, or aperture optimum for the clipped image.

With this configuration, it is possible to generate an image captured with a camera control parameter optimum for a clipped image of a partial region of a captured image by a camera, and to distribute, display, or record the image.

### REFERENCE SIGNS LIST

10 Camera
20 Captured image
31 to 33 Clipped image
50 PTZ camera
51 Captured image
100 Camera
101 Image analysis unit
102 Image clipping unit
103 Camera control unit
104 Image recording unit
105 Image output unit
106 Recording medium
120 External device
121 Recording medium
201 Imaging unit
202 Image analysis unit
203 Clipping target determination unit
204 Clipping region calculation unit
205 Clipping execution unit
206 Output unit
207 Recording processing unit
208 Recording medium
209 Camera control parameter determination unit
210 Camera control unit
221 Imaging unit
222 Output unit
223 Recording processing unit
224 Recording medium
225 Camera control unit
231 Camera control parameter determination unit
301 Input unit
302 Image analysis unit
303 Clipping target determination unit
304 Clipping region calculation unit
305 Clipping execution unit
306 Output unit
307 Recording processing unit
308 Recording medium
309 Camera control parameter determination unit
501 Input video
502 Clipping image candidate
503 Output video
504 In-clipped image subject angle of view designation unit
505 AI setting clipping region
506 Output clipping video frame
701 CPU
702 ROM
703 RAM
704 Bus
705 Input/output interface
706 Input unit
707 Output unit
708 Storage unit
709 Communication unit
710 Drive
711 Removable medium

1. The image processing device comprising:
a clipping execution unit that generates a clipped image obtained by clipping a partial region from a captured image by a camera;
a camera control parameter determination unit that determines a camera control parameter optimum for the clipped image; and
a camera control unit that causes the camera to execute image capturing to which the camera control parameter determined by the camera control parameter determination unit is applied.

2. The image processing device according to claim 1, wherein the camera control parameter determination unit determines a camera control parameter of at least one of focus, exposure, white balance (WB), shutter speed, or aperture optimum for the clipped image.

3. The image processing device according to claim 1, further comprising an image analysis unit that executes analysis processing of a captured image by the camera, wherein the image analysis unit executes detection processing of a subject to be included in the clipped image from the captured image by the camera.

4. The image processing device according to claim 3, wherein the image analysis unit executes detection processing of a person or detection processing of a face region to be included in the clipped image.

5. The image processing device according to claim 3, wherein the clipping execution unit generates a clipped image including a subject detected by the image analysis unit.

6. The image processing device according to claim 3, wherein the clipping execution unit generates a clipped image including a person region or a face region detected by the image analysis unit.

7. The image processing device according to claim 1, wherein
the image analysis unit includes a clipping target determination unit that determines a subject to be included in a clipped image generated by the clipping execution unit, and
the clipping target determination unit executes processing of determining at what angle of view a subject to be clipped is to be clipped.

8. The image processing device according to claim 7, wherein
the clipping target determination unit executes
clipping target determination processing by an operator or clipping target determination processing using AI analysis.

9. The image processing device according to claim 7, wherein the clipping target determination unit executes clipping target determination processing by using AI analysis using at least one of a machine learning model or a rule-based model.

10. The image processing device according to claim 1 wherein
the image analysis unit includes a clipping region calculation unit that calculates a clipping image region of a clipped image generated by the clipping execution unit, and
the clipping region calculation unit calculates a position and a size of the clipped image in the captured image.

11. The image processing device according to claim 1, wherein the camera control parameter determination unit determines a focus control parameter so that a main subject of the clipped image is in focus.

12. The image processing device according to claim 1, wherein the camera control parameter determination unit determines control parameters of exposure and white balance (WB) optimum for an image of the clipped image.

13. The image processing device according to claim 1, wherein the camera control parameter determination unit determines an optimum shutter speed control parameter according to motion of a main subject in the clipped image.

14. The image processing device according to claim 1, wherein the camera control parameter determination unit determines a control parameter for aperture adjustment in consideration of a distance between a main subject and a non-main subject in the clipped image.

15. The image processing device according to claim 14, wherein the control parameter for aperture adjustment is an F-number.

16. The image processing device according to claim 1, further comprising a display unit that displays a GUI including a display region of a captured image by the camera and a clipping image candidate display region for displaying a candidate image of a clipped image, wherein the GUI is a GUI that enables selection of a clipped image to be output from among a plurality of clipping image candidates displayed in the clipping image candidate display region.

17. An image processing method executed in an image processing device, the method executing:
an image clipping step of generating, by a clipping execution unit, a clipped image obtained by clipping a partial region from a captured image by a camera;
a camera control parameter determination step of determining, by a camera control parameter determination unit, a camera control parameter optimum for the clipped image; and
a camera control step of causing, by a camera control unit, the camera to execute image capturing to which the camera control parameter determined in the camera control parameter determination step is applied.

18. A program for causing an image processing device to execute image processing, the program causing the image processing device to execute:
an image clipping step of causing a clipping execution unit to generate a clipped image obtained by clipping a partial region from a captured image by a camera;
a camera control parameter determination step of causing a camera control parameter determination unit to determine a camera control parameter optimum for the clipped image; and
a camera control step of causing a camera control unit to execute causing the camera to execute image capturing to which the camera control parameter determined in the camera control parameter determination step is applied.
